(19) United States
(12) Patent Application Publication
(10) Pub. No.: US 2003/0184815 A1
(43) Pub. Date: Oct. 2, 2003

(54) Picture image printing apparatus, method of picture image printing, program and printing medium unit

(76) Inventors: Naoki Shiki, Osaka (JP); Katsuyuki Inage, Kyoto (JP); Masamichi Akima, Kyoto (JP)

Correspondence Address: DICKSTEIN SHAPIRO MORIN & OSHINSKY LLP, 2101 L STREET NW, WASHINGTON, DC, 20037-1526, US

(21) Appl. No.: 10/315,200

(22) Filed: Dec. 10, 2002

(30) Foreign Application Priority Data
Dec. 14, 2001 (JP) 2001-381519
Jan. 30, 2002 (JP) 2002-021649

(51) Int. Cl. H04N 1/21; H04N 1/387

(52) U.S. Cl. 358/453; 358/302

(57) ABSTRACT

It is contemplated to enable preferably extracting a desired region or regions in a picture image and synthesizing the same with another picture image. An edited picture image displaying section displays a picture image (referred below to as picture image to be edited) for creating a stamp picture image, which is synthesized together with another picture image. In creating a desired stamp picture image, a user operates, for example, a region addition button and then uses an input pen to paint out a region or regions which are not used as a stamp picture image, within the picture image to be edited. The region or regions as painted out are indicated as a region or regions not used as a stamp picture image, specified as transparent. When stamp picture images created are synthesized as a foreground of another picture image, only a stamp picture image corresponding to a region or regions not painted out is displayed as a foreground of another picture image and a region or regions painted out transmit through another picture image disposed in a background thereof to be displayed.

### FIELD OF THE INVENTION

The invention relates to a picture image printing apparatus, in which a desired portion or portions of a picture image can be preferably extracted and synthesized in a predetermined picture image, a method of picture image printing, a program, and a printing medium unit, and more particularly, to a picture image printing apparatus, a method of picture image printing, and a printing medium unit.

### BACKGROUND OF THE INVENTION

Picture image printing apparatus, such as the so-called Print Club®, are known in the art. These apparatus typically photograph an image of a user, synthesize this image with a frame picture image that was prepared beforehand, and print the resulting picture image on a seal paper, which is then dispensed to the user. These picture image printing apparatus also typically provide a pen that can be used to write (edit) optional letters and figures into the photographed picture image.

Furthermore, conventional picture image printing techniques, such as that disclosed in JP-A-10-308911, also allow a user to photograph a fundamental picture image and then overlay other reduced picture images on the fundamental picture image. For example, an apparatus disclosed in JP-A-10-308911 allows a user to extract and reduce a portion an image, such as a person or persons, stored on a floppy disk and then synthesize this extracted image with a fundamental picture image photographed with the apparatus. Thus, the apparatus disclosed in JP-A-10-308911 enables a user to create a picture image showing the user and a person or persons not actually present when the fundamental picture image was taken.

One problem with the image extracting technique disclosed in JP-A10-308911, however, is that extraction occurs via so-called chromakey processing, which automatically extracts only broad regions of stored picture images and thus does not allow a user to extract a desired smaller region. For example, in the case of a picture image showing a plurality of persons, it is not possible to extract only the faces of the persons or even to extract only one person using the technique disclosed in JP-A-10-308911.

### SUMMARY OF THE INVENTION

The present invention has been thought of in view of the problems discussed above and allows a user to preferably extract a desired portion or portions of a picture image and synthesize this extracted image with a fundamental picture image.

A picture image printing apparatus according to the invention comprises a photographing means for photographing a subject; a picture image selecting means for selecting a first picture image and a second picture image, said second picture image being synthesized into the first picture image, which is selected from picture images photographed by the photographing means; a region extracting means for extracting a region or regions from a second picture image for synthesis into a first picture image according to input from a user; and a synthesizing means for synthesizing the extracted region or regions of the second picture image into the first picture image.

The photographing means is composed of a photographing device, such as digital camera. The picture image selecting means, region extracting means, and synthesizing means are composed of a CPU for implementing the above processing, for example, controlling an operation of the picture image printing apparatus.

In the picture image printing apparatus, a first picture image and a second picture image are selected from picture images of the subject photographed, and a region or regions of the second picture image are extracted according to an input from a user. The extracted region or regions of the second picture image are then synthesized with the first picture image.

Accordingly, a user can synthesize the first picture image with a user determined region or regions of the second picture image. That is, it is possible to create a picture image according to a user's preferences as compared with the case where a region or regions being synthesized are automatically extracted by the chromakey processing.

According to the present invention, extracted portions of the second picture image are synthesized into the first picture image, both picture images being picture images of a subject photographed by the photographing device. That is, a user can synthesize a predetermined region of a second picture image, which the user himself has taken, into a first picture image, which the user himself has taken. Accordingly, an interesting picture image can be created.

Furthermore, a predetermined region cannot only be extracted, but also various settings may be made for the region. For example, various settings such as color, transparency or size of the second picture image may be altered.

There is further provided an input means for inputting the synthesized region or regions. The region extracting means can then extract a region or regions of the second picture image, omitting those region or regions that correspond to a locus of the input means.

The input means is composed of, for example, a pen-shaped tool, mouse, various operation buttons, or the like.

The region or regions corresponding to the locus can display a picture image or images representative of being not indicated as the synthesized region or regions.

For example, such picture images include a picture image composed of a message “not indicated as synthesized region or regions,” and since such picture image is displayed, a user can easily ascertain a region of a locus input, that is, a region having not yet been indicated as synthesized region or regions and indicate a region or regions efficiently.

There is further provided input means for inputting the synthesized region or regions, and the region extracting means can extract a region or regions of the second picture image except a region or regions surrounded by a locus of the input means as a synthesized region or regions.

The region extracting means can extract a region or regions of the second picture image, which meet with a predetermined setting relating to color and indicated by a user, as a synthesized region or regions.

The setting relating to color can comprise respective values such as R (red), G (green) and B (blue), and various values relating to elements constituting various color spaces such as luminance value, chromaticity, hue value, brightness or the like. An unexpected region or regions can be extracted by indicating these values and extracting a synthesized region or regions.

The synthesizing means can synthesize the synthesized region or regions as a foreground of the first picture image or as a background of a region of the subject of the first picture image and the first picture image.

Since the synthesized region or regions are synthesized as a foreground of the first picture image, the subject of the first picture image is in some cases hidden by the synthesized region or regions in the case where the synthesized region or regions are synthesized in the same position as that, in which the subject taken in the first picture image is present. Also, since the synthesized region or regions are synthesized as a background of a region of the subject of the first picture image, the synthesized region or regions, that is, picture images of a user are displayed in plural in a background of the user in the first picture image in the case where input of, for example, a plurality of synthesized regions in an entire first picture image is instructed. Accordingly, it is possible to create an interesting picture image.

There is further provided first flattening means for flattening an outline of a region of the subject when the synthesized region or regions are synthesized as a background of a region of the subject of the first picture image, and the synthesizing means can synthesize the synthesized region or regions as a background and the region of the subject of the first picture image, of which outline is flattened by the first flattening means.

Thereby, even in the case where the synthesized region or regions are synthesized as a background of the first picture image, a border portion thereof can be made good-looking.

There can be further provided display a means for displaying a predetermined picture image, which emphasizes the outline of the region of the subject.

The display means flickers the outline of the subject by means of a predetermined color or represents the outline by means of a conspicuous color such as red, thereby emphasizing the outline.

Thereby, in the case where the synthesized region or regions are synthesized as a background of the first picture image, the positional relationship between the synthesized region or regions and the first picture image can be easily ascertained, so that it is possible to efficiently synthesize the synthesized picture image or images in a desired position or positions.

There is further provided second flattening means for flattening an outline of the synthesized region or regions when the synthesized region or regions are synthesized as a foreground of the first picture image, and the synthesizing means can synthesize the synthesized region or regions, of which outline is flattened by the second flattening means, as a foreground of the first picture image.

Thereby, even in the case where the synthesized region or regions are synthesized as a foreground of the first picture image, a border portion thereof can be made good-looking. The first flattening means acquires a synthesized region or regions, of which outline is flattened, by making the synthesized region or regions binary, for example, a black region and a white region, representing a border portion between the two regions by means of average pixel values in the vicinity of the border portion to make the same a gray region, and overlapping the resulting picture image on the synthesized region or regions.

There is further provided a synthesized region display means for displaying the synthesized region or regions extracted by the region extracting means in a different position from the second picture image where an input from a user is received.

For example, while the synthesized region or regions as extracted can be displayed as being smaller than the second picture image for selection of the synthesized region or regions, a user can therefore easily ascertain a synthesized region or regions having been indicated by him, that is, a synthesized region or regions synthesized into the first picture image.

A picture image printing method for picture image printing apparatuses, according to the invention, comprises the steps of photographing a subject; selecting a first picture image and a second picture image from among the picture images photographed in the photographing step; extracting a synthesized region or regions from the second picture image for synthesis into the first picture image, wherein said extracted region is extracted from the second picture image by a processing of the picture image selecting step according to an input from a user; and synthesizing the extracted region or regions of the second picture image and the first picture image.

In the picture image printing method for picture image printing apparatuses, according to the invention, a subject is photographed, a first picture image and a second picture image being synthesized into the first picture image are selected among picture images of the subject photographed, and a synthesized region or regions being synthesized into the first picture image are extracted in the second picture image selected according to an input from a user. Also, the synthesized region or regions of the second picture image extracted are synthesized into the first picture image.

According to the picture image printing method, it is possible to take the same effect as that in the picture image printing apparatus according to the invention.

A program according to the invention has a feature in having a computer implementing a picture image acquisition controlling step of controlling acquisition of a picture image of a subject photographed, a picture image selecting step of selecting a first picture image and a second picture image being synthesized into the first picture image, among picture images of the subject acquired by a processing of the picture image acquisition controlling step, a region extracting step of extracting a synthesized region or regions being synthesized into the first picture image, in the second picture image selected by a processing of the picture image selecting step according to an input from a user, and a synthesizing step of synthesizing the synthesized region or regions of the second picture image extracted by a processing of the region extracting step and the first picture image.

The respective steps in the program according to the invention are composed of the steps in the same embodiment as that in the picture image printing method according to the invention.

The printing medium unit used in the picture image printing apparatus of the invention comprises storage means for storing an identifying information, which identifies the printing medium unit and has a feature in that the identifying information stored in the storage means is usable when certified by the picture image printing apparatus.

The storage means is composed of a memory such as IC tag (control tag) or IC card to store a characteristic ID as identifying information.

In this manner, the printing medium unit is made usable only when the identifying information is certified, whereby only a unit manufactured only for the picture image printing apparatus of the invention is made usable and so it is possible to suppress the use of other units than so-called genuine units. Also, in the case where a bar code is applied on a printing medium unit, such bar code may judge whether a unit in discussion is genuine.

### BRIEF DESCRIPTION OF THE DRAWINGS

FIG. 1 is a perspective view showing an outward configuration of a picture image printing apparatus on a front side, to which the invention is applied;

FIG. 2 is a perspective view showing an outward configuration of the picture image printing apparatus on a back side, to which the invention is applied;

FIG. 3 is a view showing an example of a layout of the picture image printing apparatus shown in FIG. 1;

FIG. 4 is a view showing the example of the layout of the picture image printing apparatus of FIG. 1 as viewed from above;

FIG. 5 is a block diagram showing an example configuration for the picture image printing apparatus shown in FIG. 1;

FIG. 6 is a block diagram showing a functional configuration of a control device and a photographing device in FIG. 5;

FIG. 7 is a flowchart illustrating the photographing processing in the picture image printing apparatus shown in FIG. 1;

FIG. 8 is a flowchart following the flowchart of FIG. 7 and illustrating the photographing processing in the picture image printing apparatus shown in FIG. 1;

FIG. 9 is a flowchart illustrating the edition processing in the picture image printing apparatus shown in FIG. 1;

FIG. 10 is a view showing a display example of scribble screens;

FIG. 11 is a flowchart illustrating the processing implemented in STEP S34 shown in FIG. 9;

FIG. 12 is a view showing a display example of edition screens;

FIG. 13 is a view illustrating the edition processing;

FIG. 14 is another view illustrating the edition processing;

FIG. 15 is a flowchart illustrating the processing implemented in STEP S54 shown in FIG. 1;

FIG. 16 is a view showing a further display example of edition screens;

FIG. 17 is a view showing a still further display example of edition screens;

FIG. 18 is a view showing a display example of edition screens;

FIG. 19 is a view showing a further display example of edition screens;

FIG. 20 is a flowchart illustrating the processing implemented in STEP S35 shown in FIG. 9;

FIG. 21 is a view showing a further display example of scribble screens;

FIG. 22 is a view showing a still further display example of scribble screens;

FIG. 23 is a view showing a display example of scribble screens;

FIG. 24 is a view showing a further display example of scribble screens;

FIG. 25 is a flowchart illustrating the processing implemented in STEP S106 shown in FIG. 20;

FIG. 26 is a view illustrating the flattening processing for a masking picture image;

FIGS. 27A to 27D are further views illustrating the flattening processing for a masking picture image;

FIG. 28 is a flowchart illustrating a further processing implemented in STEP S54 shown in FIG. 11;

FIG. 29 is a flowchart illustrating a still further processing implemented in STEP S54 shown in FIG. 11;

FIG. 30 is a further flowchart illustrating the edition processing in the picture image printing apparatus shown in FIG. 1;

FIG. 31 is a still further flowchart illustrating the edition processing in the picture image printing apparatus shown in FIG. 1;

FIG. 32 is a view showing an example of a picture image input by the processing in FIG. 31;

FIG. 33 is a view showing an example of a picture image input by the edition processing;

FIGS. 34A to 34G are views showing examples of picture images constituting the picture image shown in FIG. 33; FIG. 35 is a flowchart illustrating the edition processing in the picture image printing apparatus shown in FIG. 1;

FIGS. 36A and B views showing an example of a picture image input by the processing in FIG. 35;

FIG. 37 is a further view showing an example of a picture image input by the processing in FIG. 35;

FIGS. 38A to 38E are still further views showing an example of a picture image input by the processing in FIG. 35;

FIGS. 39A to 39F are views showing an example of a picture image input by the processing in FIG. 35;

FIG. 40 is a flowchart illustrating a further edition processing in the picture image printing apparatus shown in FIG. 1;

FIG. 41 is a view showing a display example of scribble screens;

FIG. 42 is a flowchart illustrating the photographing processing in the picture image printing apparatus shown in FIG. 1;

FIG. 43 is a view showing a display example of retaking screens;

FIG. 44 is a flowchart illustrating the photographing processing in the picture image printing apparatus shown in FIG. 1;

FIG. 45 is a view showing a further display example of scribble screens;

FIG. 46 is a flowchart illustrating the selection processing for arrangement of stamps in the picture image printing apparatus shown in FIG. 1;

FIG. 47 is a view showing a display example of selection screens;

FIG. 48 is a view showing a further display example of selection screens;

FIG. 49 is a view showing a still further display example of selection screens;

FIG. 50 is a view showing a display example of scribble screens;

FIG. 51 is a view showing a display example of explanation screens;

FIG. 52 is a flowchart illustrating the selection processing for arrangement of stamps in the picture image printing apparatus shown in FIG. 1;

FIG. 53 is a view showing a display example of selection screens;

FIG. 54 is a view showing a further display example of selection screens;

FIG. 55 is a view showing a still further display example of selection screens;

FIG. 56 is a view showing a display example of scribble screens;

FIG. 57 is a view showing a further display example of explanation screens; and

FIG. 58 is a view showing a further display example of scribble screens.

### DETAILED DESCRIPTION OF THE INVENTION

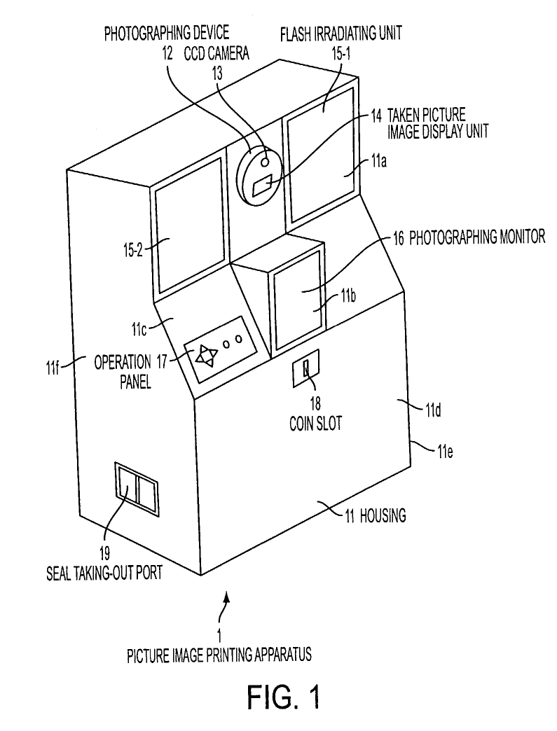

FIG. 1 is a perspective view showing a configuration of a picture image printing apparatus 1, to which the invention is applied, as an automatic photograph vending machine.

A photographing device 12 is provided centrally on an upper, vertical surface 11a of a housing 11. The photographing device 12 is oriented somewhat obliquely downward and movable vertically along a rail (not shown) provided on the surface 11a. Accordingly, a user being a subject can move the photographing device 12 vertically to taking a photograph at a desired angle.

The photographing device 12 is composed of a CCD (Charge Coupled Device) camera 13 for photographing a subject, and a taken picture image display unit 14 for displaying a picture image (motion picture image) taken by the CCD camera 13.

A flash irradiating unit 15-1 is provided on a right side of the photographing device 12, and a flash irradiating unit 15-2 is provided on a left side of the device. The flash irradiating units 15-1, 15-2 transmit a flash light emitted from an irradiation device provided inside the housing 11 in timing, at which a photograph is taken by the photographing device 12 to irradiate a subject.

Provided on a surface 11b disposed substantially centrally of the housing 11 is a photographing monitor 16 composed of a LCD (Liquid Crystal Display) or a CRT (Cathode Ray Tube). The photographing monitor 16 displays a message, which notifies a method of photographing, as well as a picture image taken, in accordance with a step of progress in a photographing processing. A user can ascertain photographed picture images displayed on the photographing monitor 16 and select a picture image, which should be kept as a picture image being an object for editing (scribbling), among the photographed picture images.

As described later, a user can make editing on a photographed picture image after the completion of photographing processing. In addition, it is possible in editing of photographed picture images to, for example, input characters, symbols and so on with a pen or apply a stamp picture image (picture image beforehand prepared). Also, a user himself can also create stamp picture images making use of photographed picture images and make editing making use of stamp picture images thus created.

An operation panel 17 is provided on a surface 11c on a left side of the surface 11b, and a user proceeds the photographing processing by means of various buttons provided on the operation panel 17. Arranged on the operation panel 17 are, for example, a “IO button” selected in determining one among various selections displayed on the photographing monitor 16, a “x button” selected in canceling a selection having been determined, an “arrow button” operated in moving a cursor up and down and right and left displayed on the photographing monitor 16, and the like. Also, a “photographing start button” operated at the start of photographing is also suitably arranged on the operation panel.

A coin slot 18 is provided on a substantially vertical surface 11d of the housing 11 below the photographing monitor 16. A user throws a predetermined fee into the coin slot 18 when taking a photograph making use of the picture image printing apparatus 1.

A seal taking-out port 19 is provided on a lower portion of a left side surface 11f of the housing 11. The various types of picture images photographed and edited are printed on a seal paper, which is sectioned into a predetermined number of portions. Finished printed picture images are discharged from the seal taking-out port 19.

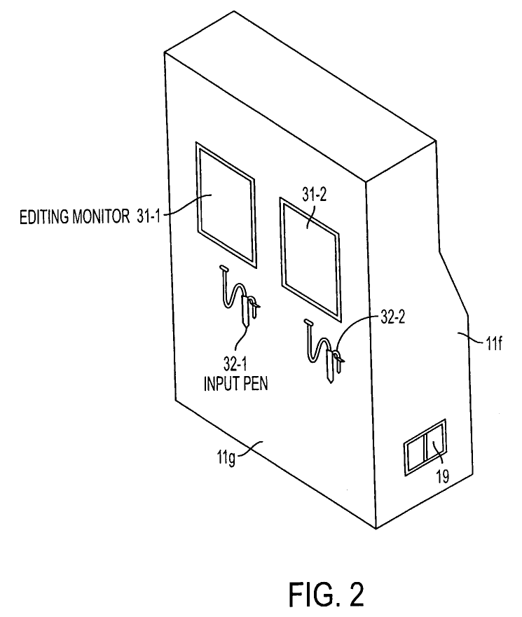

FIG. 2 is a perspective view showing a configuration on a side of a surface 11g corresponding to an opposite side of the surface 11a of the housing 11. In addition, an explanation will be suitably given below such that a surface, on which the surfaces 11a, 11b, 11c or the like are provided, is referred to as a front surf ace of the housing 11 and a surf ace, on which the surface 11g on an opposite side of the surface 11a or the like is provided, is referred to as a back surface of the housing.

Editing monitors 31-1, 31-2 are provided on the surface 11g of the housing 11 in a horizontally aligned state, and input pens 32-1, 32-2, respectively, are provided in the vicinity of the monitors. Hereinafter, in the case where there is no need to discriminate between the editing monitors 31-1, 31-2, the monitors are collectively referred to as an editing monitor 31, and in the case where there is no need to discriminating between the input pens 32-1, 32-2, the input pens are collectively referred to as an input pen 32. This same convention will also be applied to the description of other aspects of the invention.

Picture images photographed by the CCD camera 13 and selected as picture images for objects of edition are displayed respectively on the editing monitor 31 after a user has completed a photographing processing. Touch panels are laminated on the editing monitor 31, and a user can use the input pen 32 to write (input) optional letters and pictures on a picture image displayed on the editing monitor 31.

That is, after having performed the photographing processing step in a space (referred to below to as a photographing space) facing the front surface of the housing 11, a user moves to a space (referred to below as an editing space) facing the back surface of the housing 11 to perform the editing step on the photographed picture images.

Displayed on the editing monitor 31 are buttons for selection of various editing tools, together with photographed picture images for objects of edition. When the buttons displayed are operated and editing of photographed picture images is performed, a picture image or picture images having been edited and created according to an input are displayed on the editing monitor 31.

The input pen 32 is configured in accordance with a position detecting system (for example, resistance-film system, ultrasonic wave system or the like) of touch panels laminated on the editing monitor 31, and when the pen is not used for editing, it is mounted on a projection installed on the surface 11g as shown in the figure.

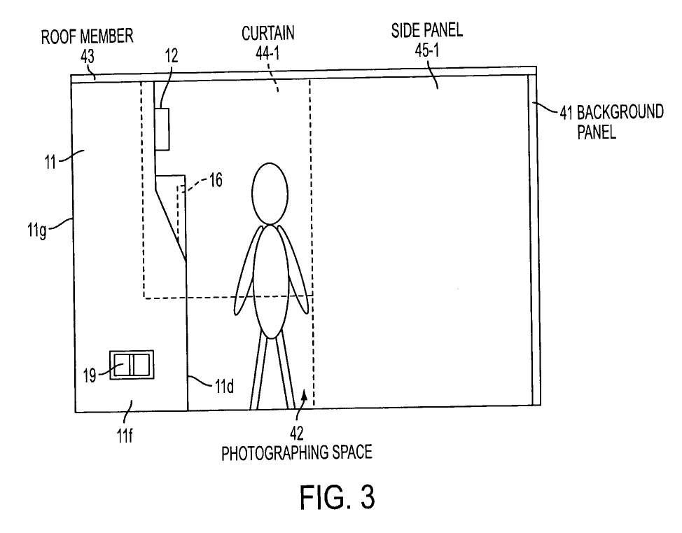

FIG. 3 is a view showing an example of a layout of the picture image printing apparatus 1 shown in FIG. 1.

A background panel 41 is installed on a position facing the front surface of the housing 11 to be spaced a predetermined distance from the front surface, and a user takes a photograph in a photographing space 42 between the housing 11 and the background panel 41. In addition, provided on the photographing space 42 are a roof member 43 supported by an upper surface of the housing 11 and the background panel 41, a curtain 44-1, and a side panel 45-1 (both are shown by chain lines) for preventing an interior of the photographing space 42 from been seen from outside.

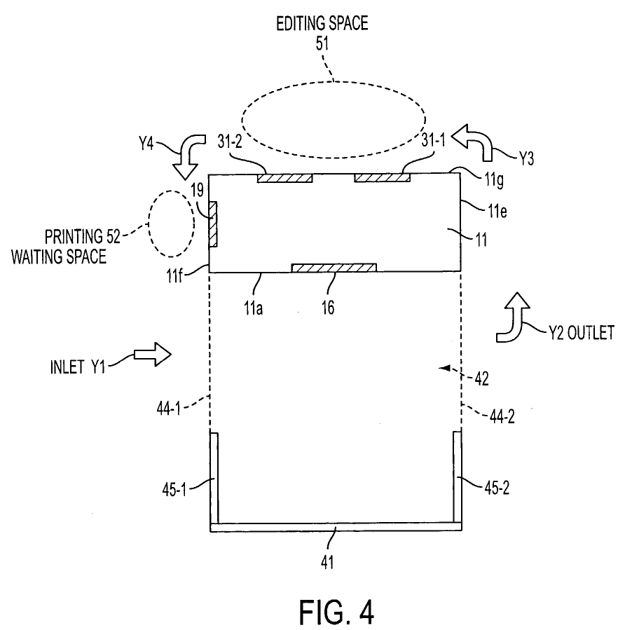

FIG. 4 is a view showing the example of the layout of the picture image printing apparatus 1 of FIG. 1 as viewed from above the housing 11. As shown in the figure, like the side of the surface 11f, provided on a side of the surface 11e of the housing 11 are a curtain 44-2 and a side panel 45-2 for preventing an interior of the photographing space 42 from been seen from outside.

Referring to FIG. 4, an explanation will be given as to movements of a user from the start of photographing to the receipt of a seal paper with the desired image printed thereon.

In using the picture image printing apparatus 1, a user enters the photographing space 42 as indicated by an outlined arrow Y1 to perform a photographing processing. Then having selected a predetermined number of picture images and completed photographing, a user leaves the photographing space 42 as indicated by, for example, an outlined arrow Y2 and moves to an editing space 51 provided on a side of the back surface of the housing 11. Naturally, a user may leave the inlet and move to the editing space 51 depending upon the layout of the apparatus.

As described above, since a picture image or picture images having been photographed and selected in the photographing space 42 are displayed in the editing monitor 31, which can be ascertained from the editing space 51, a user performs editing in a desirable manner. Having completed editing, a user moves to a printing waiting space 52 located facing the surface 11f of the housing 11, and waits until a picture image or picture images thus edited are printed on a seal paper to be discharged.

Then, when the seal paper is discharged to the seal taking-out port 19, a user receives them and closes the use of the picture image printing apparatus. A guide for these movements is given by the photographing monitor 16, the editing monitor 31, or a speaker (not shown).

In this manner, the spaces for photographing, performing edition, and waiting until the printing is terminated are provided in front of different surfaces of the housing 11, whereby the photographing processing, editing processing, and printing processing can be made to perform in parallel with one another. In this way, customers can rotate between the various areas of the picture image printing apparatus 1, which allows the number of customers making use of the picture image printing apparatus 1 to be increased as compared with a layout in which one space is allotted to perform all of these processes. Furthermore, the layout of the processing steps as described above gives the user the more time, which is required for photographing processing and editing processing.

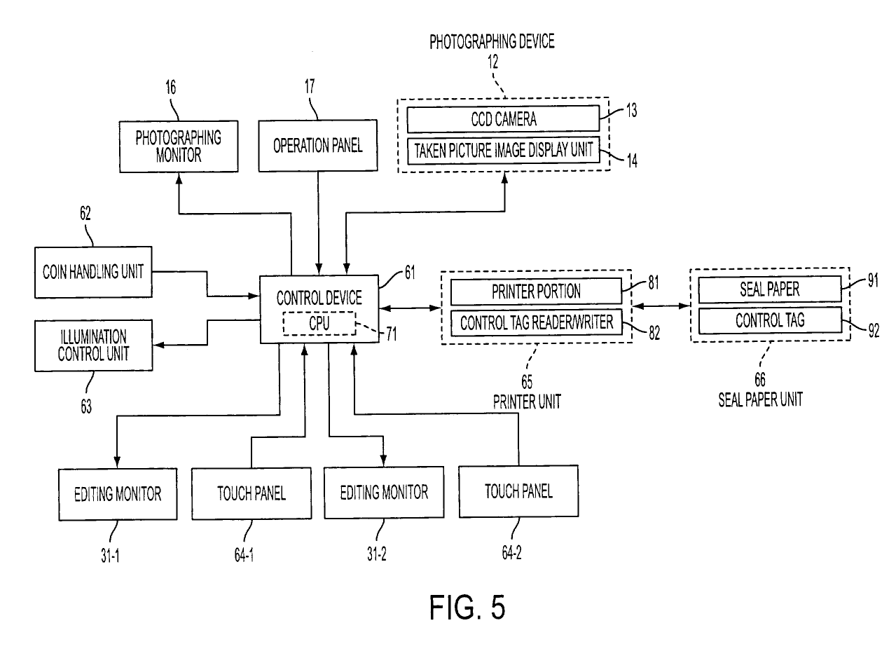

FIG. 5 is a block diagram showing a configurational example of an interior of the picture image printing apparatus 1. A detailed explanation will be omitted with respect to a similar configuration to that described above.

A control device 61 composed of a personal computer or the like controls an entire operation of the picture image printing apparatus 1. A CPU (Central Processing Unit) 71 provided in the control device 61 is used to implement various processing in accordance with programs stored in a ROM (Read Only Memory) (not shown) and a hard disk.

When a user throws a predetermined fee into the coin slot 18, a coin handling unit 62 detects the fee and informs the control device 61 thereof. An illumination control unit 63 emits a flash light on the basis of an instruction from the control device 61 in conformity to a timing, at which the photographing device 12 takes a photograph of a subject. The emitting flash light irradiates a subject (user) through the flash irradiating units 15-1, 15-2 shown in FIG. 1.

A touch panel 64-1 is laminated on the editing monitor 31-1 provided on the surface 11 of the housing 11, and a touch panel 64-2 is laminated on the editing monitor 31-2 provided on the surface. The touch panel 64 (touch panels 64-1, 642) outputs to the control device 61 an instruction input by a user through the input pens 32-1. 32-2.

A printer unit 65 is composed of a printer portion 81 and a control tog reader/writer 82, and seal paper units 66 mounted on the printer unit 65 is composed of a seal paper 91, and a control tag 92 for managing identifying information or the like, by which individual seal paper units 66 are discriminated.

When picture image data having been subjected to an editing processing or the like is supplied from the control device 61, the printer portion 81 prints the supplied picture image data on a seal paper 91, on which a plurality of seals are arranged in predetermined positions and sized, and discharges the seal paper 91 to the seal taking-out port 19.

An identifying information stored in the control tag 92 is read through contact or non-contact by the control tag reader/writer 82 and output to the control device 61. On the basis of the identifying information supplied from the control tag reader/writer 82, the control device 61 determines whether a seal paper unit 66 as mounted is one available in the picture image printing apparatus 1, and makes the printer portion 81 or the like operable only when the associated unit 66 is determined to be an available one. That is, an identifying information of a seal paper unit made available in the picture image printing apparatus 1 is managed in the control device 61. Thereby, a seal paper (not genuine) conformed to the picture image printing apparatus 1 can be suppressed in use. Also, a residual quantity of the seal paper 91 or the like is also controlled by the control tag 92. In addition, a bar code printed on a seal paper unit may be used to ascertain whether the seal paper unit is genuine or not.

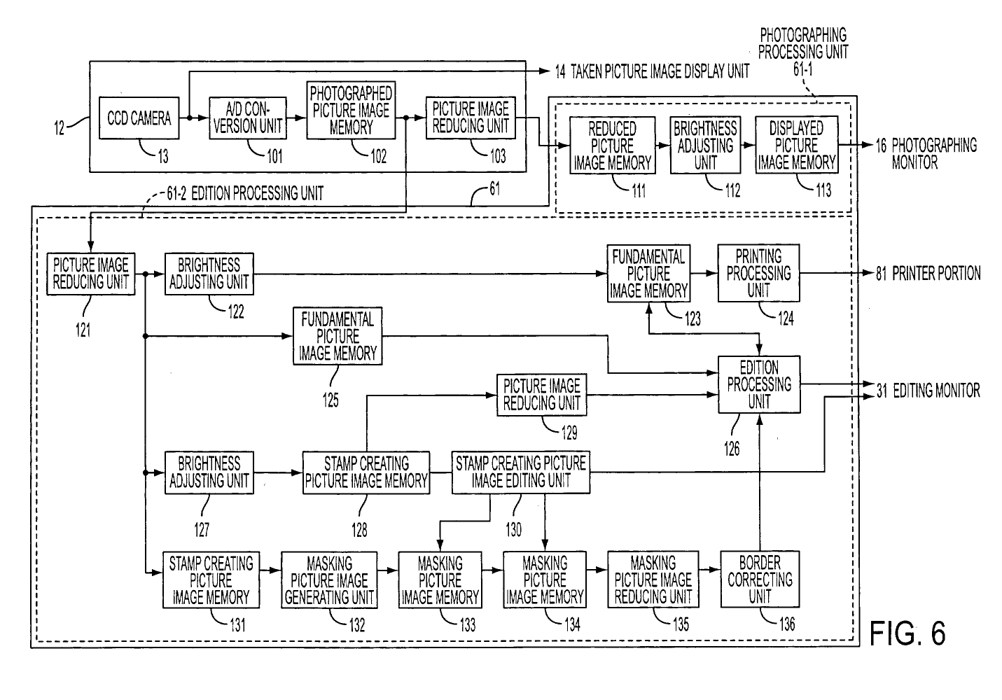

FIG. 6 is a block diagram showing a functional configuration of the photographing device 12 and the control device 61.

The functional configuration is such that programs stored in a ROM of the control device 61 and a hard disk (both are not shown) are implemented by the CPU 71. In addition, the control device 61 is composed of a photographing processing unit 61-1 for performing various processing according to input from the operation panel 17 in the photographing processing, and an edition processing unit 61-2 for performing various processes according to input from the touch panel 64 in the editing processing.

The CCD camera 13 of the photographing device 12 outputs a taken picture image signal to the taken picture image display unit 14 to cause the same to display a motion picture image. Also, the picture image taken by the CCD camera 13 is output to an A/D (Analog/Digital) conversion unit 101 and temporarily kept in a photographed picture image memory 102 after having been subjected to A/D conversion processing by the A/D conversion unit 101.

Picture image data kept in the photographed picture image memory 102 is reduced to a predetermined size in a picture image reducing unit 103 so as to cause a user to ascertain photographed picture images, after which the picture image data is kept in a reduced picture image memory 111. A brightness adjusting unit 112 adjusts brightness of picture images kept in the reduced picture image memory 111 on the basis of an input from the operation panel 17 and causes a displayed picture image memory 113 to store the picture images thus obtained. The photographed picture images kept in the displayed picture image memory 113 are displayed on the photographing monitor 16 to be presented to a user.

A user performs photographing processing by selecting respective predetermined numbers of picture images (referred to below as picture images for creation of stamps), which are used for creation of stamps in a subsequent editing processing, and picture images (referred to below as fundamental picture images), which are to be edited by means of various pens and stamps selected from the picture images displayed on the photographing monitor 16.

A picture image reducing unit 121 of the edition processing unit 61-2 reduces fundamental picture images temporarily kept in the photographed picture image memory 102 to predetermined sizes and outputs the same to a brightness adjusting unit 122 and a fundamental picture image memory 125. Also, the picture image reducing unit 121 reduces sizes of picture images for creation of stamps, kept in the photographed picture image memory 102 and outputs the same to a brightness adjusting unit 127 and a stamp creating picture image memory 131.

The brightness adjusting unit 122 adjusts brightness of fundamental picture images on the basis of parameters or the like informed from the brightness adjusting unit 112 of the photographing processing unit 61-1 and causes a fundamental picture image memory 123 to keep picture image data thus obtained. The fundamental picture images kept in the fundamental picture image memory 123 are suitably read by an edition processing unit 126 to be subjected to edition processing thereby, and thereafter are again stored in the fundamental picture image memory 123. In addition, a plurality of regions are set in the fundamental picture image memory 123 to keep a predetermined number of fundamental picture images having been acquired in the photographing processing.

When completion of the edition processing is instructed by a user, a printing processing unit 124 supplies picture image data kept in the fundamental picture image memory 123 to the printer portion, 81 of the printer unit 65 to cause the same to print the data on a seal paper 91.

Fundamental picture images reduced by the picture image reducing unit 121 are kept in a fundamental picture image memory 125 as original picture images being not subjected to brightness adjustment or the like, which picture images are suitably supplied to the edition processing unit 126. A plurality of fundamental picture images corresponding to the number of times of photographing are stored in the fundamental picture image memory 125 as in the fundamental picture image memory 123, and such fundamental picture images are utilized in determining whether stamp picture images are regions capable of synthesizing when, for example, the stamp picture images are synthesized as a background for a region of a subject of the fundamental picture images.

The edition processing unit 126 causes fundamental picture images stored in the fundamental picture image memory 123 to be displayed on the editing monitor 31, in which picture images being edited are selected, and causes picture images for creation of stamps, which are stored in a stamp creating picture image memory 128 and reduced by a picture image reducing unit 129, to be displayed on the editing monitor 31, in which picture images for creation of stamps are selected.

Also, when edition of fundamental picture images is instructed from the touch panel 64, the edition processing unit 126 edits the fundamental picture images on the basis of such instruction and causes picture images thus obtained to be displayed on the editing monitor 31 and to be kept in the fundamental picture image memory 123. Further, the edition processing unit 126 creates stamp picture images from masking picture images supplied from a border correcting unit 136 and stamp creating picture images supplied from the picture image reducing unit 129, synthesizes them in predetermined positions on the fundamental picture image, and causes synthesized picture images thus obtained to be displayed on the editing monitor 31.

Like the brightness adjusting unit 122, the brightness adjusting unit 127 adjusts brightness of picture images for creation of stamps on the basis of parameters or the like informed from the brightness adjusting unit 112 and causes picture images thus obtained to be kept in the stamp creating picture image memory 128. A plurality of regions are set in the stamp creating picture image memory 128 to keep a predetermined number of picture images for creation of stamps having been acquired in the photographing processing. The number of picture images for creation of stamps corresponding to the number of times of photographing are likewise stored in the stamp creating picture image memory 131.

The picture images for creation of stamps kept in the stamp creating picture image memory 128 are read by, for example, the picture image reducing unit 129 and a stamp creating picture image editing unit 130 to be displayed on the editing monitor 31.

As described later, the stamp creating picture image editing unit 130 edits masking picture images stored in a masking picture image memory 134 on the basis of an input from the touch panel 64 and causes stamp picture images created from the edited masking picture images to be displayed on the editing monitor 31.

A masking picture image generating unit 132 performs binary coding of picture images for creation of stamps, kept in the stamp creating picture image memory 131 into RGB (0, 0, 0) (black) and RGB (255, 255, 255) (white) to generate masking picture images. The masking picture images generated by the masking picture image generating unit 132 are kept in a masking picture image memory 133, and copied into the masking picture image memory 134 when a user creates stamp picture images. As described later, a user can create stamp picture images composed of desired regions in picture images f or creation of stamps such that predetermined regions in picture images for creation of stamps are instructed by the input pen 32, such instruction is reflected on the masking picture images stored in the masking picture image memory 134.

The masking picture images edited by the stamp creating picture image editing unit 130 are reduced by a picture image reducing unit 135, and then supplied to the border correcting unit 136. The border correcting unit 136 flattens (gradates) borders (borders between the black regions and the white regions) of the masking picture images and outputs the masking picture images thus obtained to the edition processing unit 126.

An explanation will be given below to an operation of the picture image printing apparatus 1 constructed in the above manner.

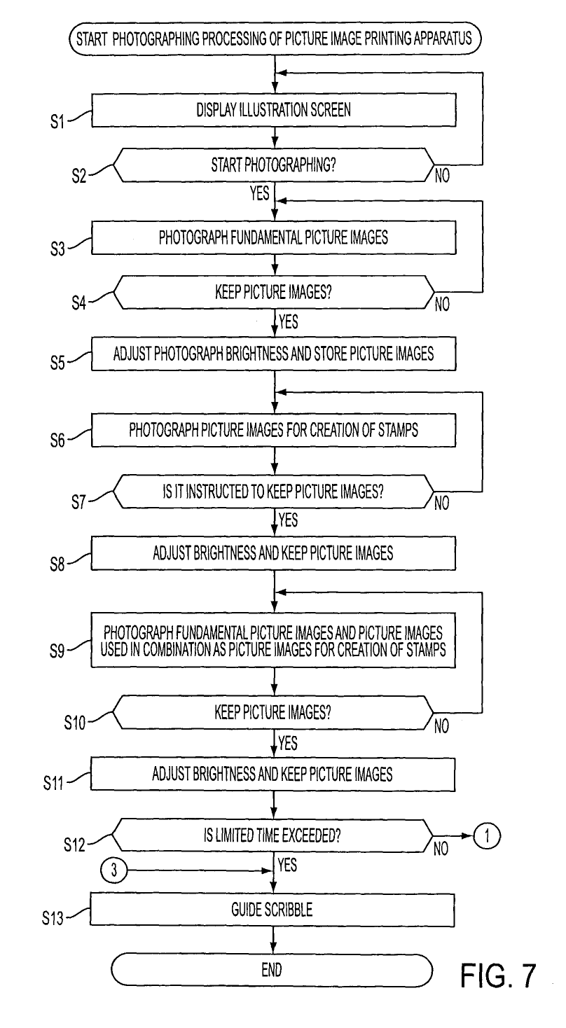

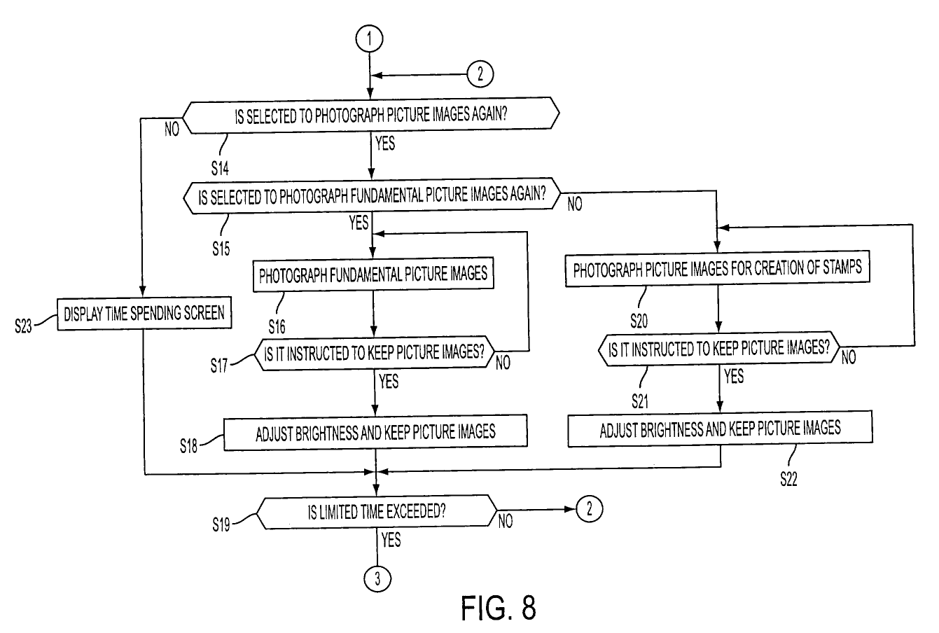

First, an explanation will be given to photographing processing in the photographing space 42 with reference to flowcharts shown in FIGS. 7 and 8.

When it is determined on the basis of an output from the coin handling unit 62 that a predetermined fee is thrown in, the CPU 71 in the control device 61 causes the photographing monitor 16 in STEP S1 to display an illustration screen, which illustrates a method of photographing (method of proceeding a game). A user adjusts the level and angle of the photographing device 12 in accordance with the illustration screen as displayed, and instructs them from predetermined buttons on the operation panel 17 when photographing is started.

The CPU 71 judges in STEP S2 whether the start of photographing is instructed, returning to STEP S1 to continue displaying of the illustration screen in the case of judging that such instruction has not been given, and proceeding to STEP S3 in the case of judging that the start of photographing has been instructed.

In STEP S3, the CPU 71 causes photographing of fundamental picture images (picture images are edited by a pen tool and a stamp tool in the edition processing). When a user operates a predetermined photographing-starting button and so on, the CPU 71 causes the photographing monitor 16 to display a countdown indicator representative of a timing for photographing, and when the timing for photographing comes, causes picture images taken by the CCD camera 13 to be subjected to AND conversion by the A/D conversion unit 101 and to make the photographed picture image memory 102 temporarily keep fundamental picture image data thus obtained. The fundamental picture image data temporarily kept in the photographed picture image memory 102 is reduced in the picture image reducing unit 121, and then kept in the fundamental picture image memories 123, 125.

In addition, motion picture images having been taken by the CCD camera 13 are displayed on the taken picture image display unit 14 provided in the vicinity of the CCD camera 13, so that a user can ascertain picture images photographed in a state, in which his eyes meets the CCD camera 13.

The CPU 71 causes the photographing monitor 16 to display picture images having been kept in the fundamental picture image memory 123 and the like, and permits a user to select whether picture images photographed should be kept as fundamental picture images.

In STEP S4, the CPU 71 judges whether it has been instructed to keep the photographed picture images, and returns to STEP S3 to take a photograph of fundamental picture images likewise in the case of judging that such instruction is not given. In addition, picture images having been instructed not to be kept are erased from the fundamental picture image memory 123 and the like.

Meanwhile, in the case where it is determined in STEP S4 that it is instructed to keep photographed picture images, the CPU 71 proceeds to STEP S5 to cause the photographing monitor 16 to display an adjustment screen for adjusting brightness of fundamental picture images to adjust brightness by means of the brightness adjusting unit 122 on the basis of an input from the operation panel 17 (keep a parameter of adjusting brightness), and then fundamental picture image data thus obtained is caused to be kept in the fundamental picture image memory 123.

Subsequently, photographing of picture images for creation of stamps, or the like is performed in STEP S6 to STEP S8 in the same manner as in STEP S3 to STEP S5. That is, the CPU 71 then presents to a user photographing of picture images for creation of stamps, and picture images for creation of stamps are photographed in STEP S6. The photographed picture images for creation of stamps are temporarily kept in the photographed picture image memory 102 to be reduced, and then displayed on the photographing monitor 16. The picture images for creation of stamps temporarily kept in the photographed picture image memory 102 are supplied to the edition processing unit 61-2 to be reduced by the picture image reducing unit 121, and then kept in the stamp creating picture image memories 128, 131.

A user ascertains picture images for creation of stamps displayed on the photographing monitor 16 and gives an instruction that when the picture images are kept, the picture images be kept after adjustment of brightness of the picture images. In the case where it is determined in STEP S7 that it has been instructed to keep picture images for creation of stamps, the CPU 71 proceeds to STEP S8, in which picture images stored in the stamp creating picture image memory 128 are adjusted in brightness by the brightness adjusting unit 127 and kept as picture images for creation of stamps, used in a subsequent editing processing.

Subsequently, in STEP S9 to STEP S11, the CPU 71 causes photographing of fundamental picture images and picture images used as picture images for creation of stamps, in combination. When a user instructs keeping photographed picture images, they are kept in the fundamental picture image memories 123, 125 and the stamp creating picture image memories 128, 131 in STEP S11.

The above processings are repeated multiple times, whereby a predetermined number of fundamental picture images and picture images for creation of stamps are stored in the fundamental picture image memories 123, 125 and the stamp creating picture image memories 128, 131.

In STEP S12, the CPU 71 determines whether a limited time preset for the photographing processing has been exceeded since the start of the photographing processing, and when it is determined that the limited time has been exceeded, proceeds to STEP S13, in which processing of scribble (edition) is guided. For example, the CPU 71 causes the photographing monitor 16 to display a guide screen for guiding movement from the photographing space 42 to the editing space 51. This guide screen states, “Please come around to the back side.” Thus, a user is instructed to terminate the photographing processing and proceed to the scribble step.

Meanwhile, in the case where it is determined in STEP S12 that the limited time has not been exceeded, the CPU 71 proceeds to STEP S14, in which picture images kept are photographed again until the limited time is reached. That is, when photographing processing is performed in the photographing space 42, another user in some cases performs edition processing in the editing space 51 in parallel therewith, so that the photographing processing or the like is continued until the limited time is reached.

Determining in STEP S14 whether it is selected to photograph the picture images again, the CPU 71 proceeds to STEP S15 in the case where it is determined that it is selected to perform photographing again, and subsequently determines whether it is instructed to photograph fundamental picture images again. That is, the photographing monitor 16 to display a screen for selection of which picture image or picture images should be photographed again among fundamental picture images and picture images for creation of stamps.

In the case where it is determined in STEP S15 that it is instructed to photograph fundamental picture images again, the CPU 71 causes, in STEP S16 to STEP S18, photographing of fundamental picture images in the same manner as described above. Determining in STEP S19 whether the limited time has been exceeded, the CPU 71 proceeds to STEP S13 in the case where it is determined that the limited time has been exceeded, and guides scribble. In the case where it is determined in STEP S19 that the limited time has not been exceeded, the CPU 71 returns to STEP S14 and implements the succeeding processings repeatedly.

Meanwhile, in the case where it is determined in STEP S15 that it is not instructed to photograph fundamental picture images again (it is instructed to photograph picture images for creation of stamps again), the CPU 71 causes, in STEP S20 to STEP S22, photographing of picture images for creation of stamps in the same manner as in the processing described above and implements the processings subsequent to STEP S19.

In addition, certain games are prepared for a user who does not want to photograph picture images again, and thus in the case where it is determined in STEP S14 that it is not selected to photograph picture images again, the CPU 71 causes displaying of a time spending screen (game screen or the like) in STEP S23. Thereafter, when the limited time is reached, scribble is guided for a user whereby the photographing processing is terminated.

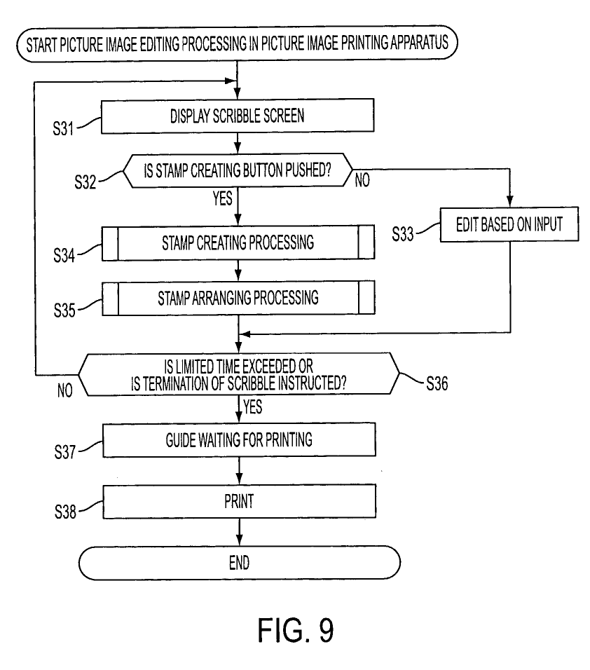

An explanation will be given below to an edition processing in the editing space 51 with reference to a flowchart shown in FIG. 9.

In STEP S31, the CPU 71 causes the editing monitors 31-1, 31-2 to display scribble screens for a user having moved to the editing space 51 from the photographing space 42. Naturally, a scribble screen may be displayed only on either of the editing monitors.

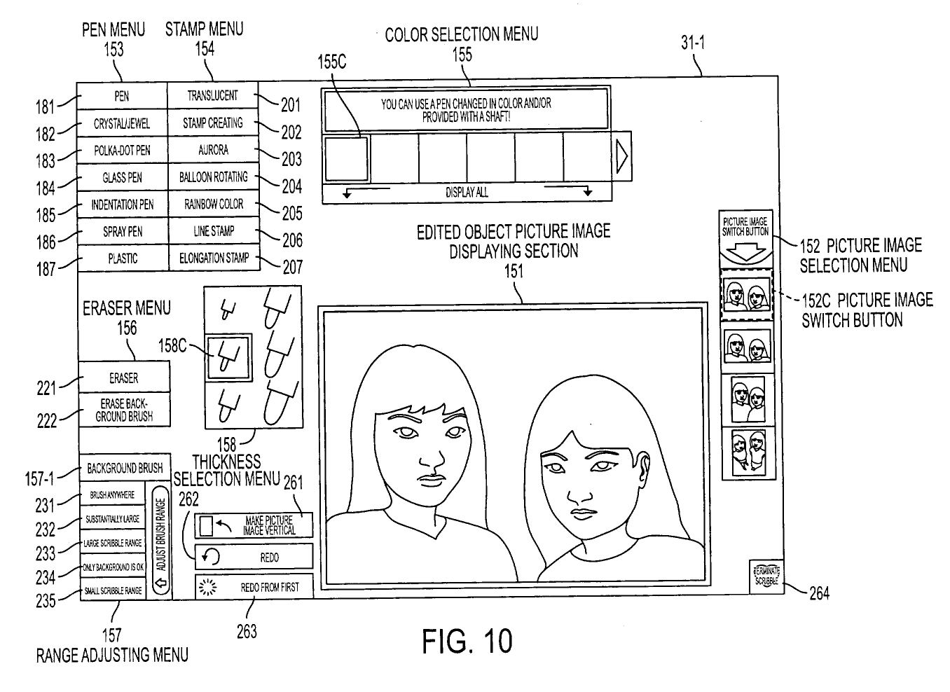

FIG. 10 is a view showing an example of scribble screens displayed on the editing monitor 31-1.

Displayed on the scribble screen are, for example, an edited object picture image displaying section 151, which displays a picture image for edition (referred suitably below to as edited object picture image), selected from a plurality of fundamental picture images having been kept, and a picture image selection menu 152 for selection of an edited object picture image, rightward of the section. Also, there are displayed a pen menu 153 operated in selecting a “pen tool” for inputting lines, letters and so on into an edited object picture image; a stamp menu 154 operated in selecting a “stamp tool, for arranging a predetermined stamp picture image or picture images on an edited object picture image; and a color selection menu 155 operated in selecting a color of “pen tool.” Further, there are displayed an eraser menu 156 operated in selecting a “eraser tool” for erasing scribble or the like once input; a range adjusting menu 157 operated in selecting a “background brush tool” for arranging a preferred texture in a background portion of a subject and a range of the texture; and a thickness selection menu 158 operated in selecting the “pen tool” thickness.

Since fundamental picture images having been photographed in the photographing processing are displayed on the picture image selection menu 152 in thumbnail representation, a user moves a cursor 152C to select an edited object picture image from the fundamental picture images as displayed. In an example shown in FIG. 10, four kinds of fundamental picture images are displayed on the picture image selection menu 152 in thumbnail representation, and a fundamental picture image displayed at the topmost is selected as an edited object picture image by the cursor 152C. Accordingly, the picture image disposed at the topmost and selected by the cursor 152C is displayed on the edited object picture image displaying section 151 in enlarged scale.

Provided on the pen menu 153 are a “pen” button 181 operated in selecting, for example, an ordinary (single color and non-pattern) pen tool, a “crystal & jewel pen” button 182 operated in selecting a pen tool for displaying of scribble letters or the like in a crystal representation, a “polka dot pen” button 183 operated in selecting a pen tool for application of a polka-dot pattern on scribble letters or the like, and a “glass pen” button 184 operated in selecting a pen tool for displaying of scribble letters or the like in a translucent fashion. Also provided are an “indentation pen” button 185 operated in selecting a pen tool for displaying of scribble letters or the like in an outline of indentation, a “spray pen” button 186 operated in selecting a pen tool for displaying of scribble letters or the like in a blurred outline, and a “plastic pen” button 187 operated in selecting a pen tool for displaying of scribble letters or the like in a three-dimensional manner.

A user uses the input pen 32 to select a desired pen tool provided on the pen menu 153 and applies scribble on an edited object picture image with the use of the selected pen tool.

Provided on the stamp menu 154 are a “translucent stamp” button 201 operated in selecting, for example, a stamp tool for displaying in a translucent fashion, a “stamp creating” button 202 operated in creating a stamp or stamps from picture images for creation of stamps kept in the photographing processing, and an “aurora stamp” button 203 operated in selecting a stamp tool, which is changed in color according to a period of time, during which the input pen 32 is caused to abut against the editing monitor 31.

Also, arranged on the stamp menu 154 are a “balloon rotating stamp” button 204 operated in selecting a stamp tool, by which a stamp picture image is rotated and displayed according to a period of time, during which the input pen 32 is caused to abut against the editing monitor 31, a “rainbow color stamp” button 205 operated in selecting a stamp tool sequentially displayed in different colors, a “line stamp” button 206 operated in selecting a stamp tool, in which plural kinds of stamp tools are continuously connected to one another and displayed, and an “elongation stamp” button 207 operated in selecting a stamp tool for arranging a picture image of, for example, a head portion of a dog in a position, which is touched by the input pen 32, and displaying a picture image of a dog's trunk according to a locus of the input pen 32.

A user uses the input pen 32 to select a desired stamp tool to indicate a position in which the tool should be positioned, thereby enabling synthesizing the selected stamp picture image and an edited object picture image. In particular, a detailed explanation will be given later to a stamp creation processing implemented when the stamp creating button 202 is operated.

In the example of the scribble screen shown in FIG. 10, six kinds of colors are prepared for the color selection menu 155, and a user uses the input pen 32 to move a cursor 155C, thus enabling selecting a desired color.

Arranged on the eraser menu 156 are an “eraser” button 221 operated in erasing scribble input by a pen tool, a stamp picture image input by a stamp tool, and a background brush picture image input by the background brush tool, and a “background brush eraser” button 222 operated in erasing only a background picture image input by the background brush tool.

Arranged on the range adjusting menu 157 are a background brush button 157-1 operated when a background brush tool for synthesizing a texture, which is prepared beforehand, and a background of a subject, is used and range adjusting buttons 231 to 235 operated in selecting an input range of the button.

Prepared in the thickness selection menu 158 are six kinds of thicknesses for scribble input by the pen tool. The user moves a cursor 158C to select a desired thickness.

In the example of the scribble screen shown in FIG. 10, there are provided in addition to the above buttons a “direction changing” button 261 operated in selecting a direction of an edited object picture image (a longitudinal picture, image or a horizontally long picture image), a “redoing” button 262 operated in redoing (erasing) scribble having already been input, a “redoing from first” button 263 operated in redoing scribble from the first, and a “scribble terminating” button 264 operated in terminating the scribble processing.

Referring again to FIG. 9, determining in STEP S32 whether the “stamp creating” button 202 is operated, the CPU 71 proceeds to STEP S33 in the case where it is determined that the “stamp creating” button 202 is not operated, and edits an edited object picture image on the basis of an input from a user.

That is, the CPU 71 causes the edition processing unit 126 to synthesize a picture image created by the pen tool, a picture image created by the stamp tool, or the like with fundamental picture images kept in the fundamental picture image memory 123, in accordance with an input from the touch panel 64. A synthesized picture image synthesized and obtained by the edition processing unit 126 is displayed on the edited object picture image displaying section 151 of the editing monitor 31 and kept in the fundamental picture image memory 123.

Meanwhile, in the case where it is determined in STEP S32 that the “stamp creating” button 202 is operated, the CPU 71 proceeds to STEP S34 to perform the stamp creating processing. A user uses the input pen 32 to indicate a region of an edited object picture image selected as an object of edition, which region is used as a stamp picture image (referred to below as stamp picture image region), and creates a stamp picture image. As described later, a user can indicate a desired region, such as his eyes and a surrounding portion, or his face and a surrounding portion in, for example, a picture image photographed for creation of stamps, as a stamp picture image, and synthesize the same and a fundamental picture image.

When the stamp editing processing is terminated, the CPU 71 proceeds to STEP S35 to perform the stamp positioning processing. That is, the CPU 71 performs synthesizing of that stamp picture image, which has been created in STEP S34, in that position on an edited object picture image, which is indicated by a user. A user can arrange the created stamp as a background of a subject displayed on a fundamental picture image or a foreground of a subject.

The CPU 71 determines in STEP S36 whether a limited time preset for the editing processing is exceeded, or whether a user operates a scribble terminating button 264 to instruct termination of scribble.

In the case where it is determined in STEP S36 that the limited time preset for the editing processing is not exceeded and termination of scribble is not instructed by a user, the CPU 71 returns to STEP S31 to repeatedly implement the succeeding processing.

Thereby, a user can apply edition such as scribble on respective picture images having been kept as fundamental picture images.

Meanwhile, in the case where it is determined in STEP S36 that the limited time preset for the editing processing is exceeded, or termination of scribble is instructed by a user, the CPU 71 proceeds to STEP S37 to guide a user, who has terminated the editing processing, in waiting for printing. That is, the CPU 71 causes the editing monitor 31 to display a message for guiding a movement to the printing waiting space 52, for example, “Please come around to the seal taking-out port”.

In STEP S38, the CPU 71 causes the printing processing unit 124 to drive the printer portion 81 to print on a seal paper 91 picture images kept in the fundamental picture image memory 123. In the printer portion 81, a predetermined number of picture images having been edited ar6 printed in predetermined positions on the basis of the number of portions, into which a seal paper 91 is sectioned and which is selected by a user. In addition, a predetermined selection screen is displayed on the photographing monitor 16 or the editing monitor 31 in a predetermined timing to allow a user to select the number of portions, into which a desired seal paper 91 is sectioned.

The stamp picture image creating processing of the control device 61 implemented in STEP S34 shown in FIG. 9 will be described below with reference to a flowchart shown in FIG.

In STEP S51, the CPU 71 causes the editing monitor 31 to display a stamp creating screen.

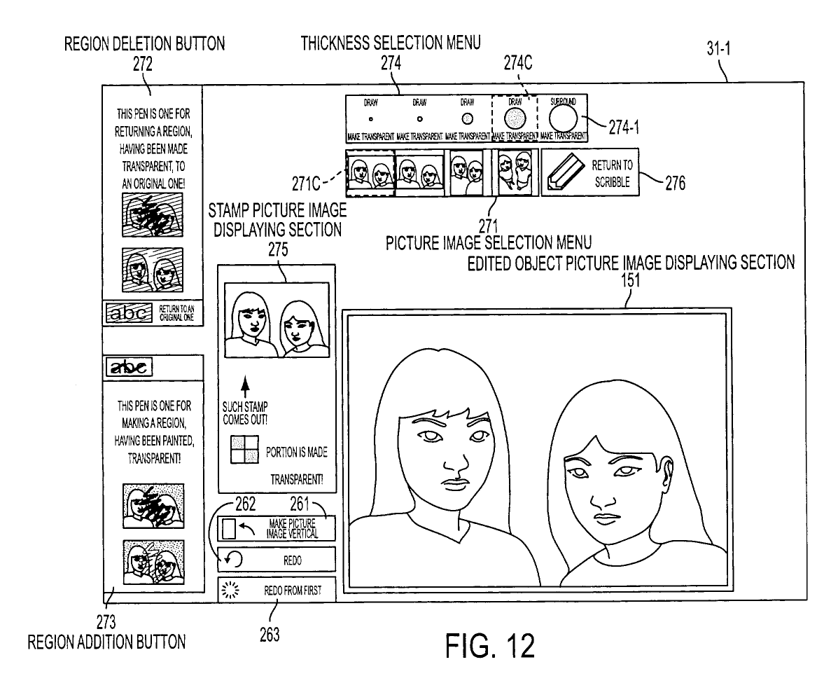

FIG. 12 is a view showing a display example of a stamp creating screen. The same portions as those shown in FIG. 10 are denoted by the same reference numerals.

Picture images for creation of stamps, kept in the photographing processing are read by the stamp creating picture image memory 128 shown in FIG. 6 are displayed on the edited object picture image displaying section 151 in a stamp creating screen by the edition processing unit 126.

Picture images for creation of stamps are displayed on a picture image selection menu 271 in thumbnail representation, and a user moves a cursor 271C to be able to select a desired picture image for creation of stamps. In an example shown in FIG. 12, a picture image for creation of stamps, displayed on a leftmost side, among picture images for creation of stamps displayed in thumbnail representation is selected and displayed in enlarged scale on the edited object picture image displaying section 151.

A user can create a picture image for creation of stamps by using the input pen 32 to paint over a region not used as a stamp picture image on a picture image for creation of stamps displayed on the edited object picture image displaying section 151. The region painted over by the input pen 32 becomes transparent and a picture image is displayed to indicate that the region is one not used as a stamp picture image. Thereby, a user can ascertain at a glance that the region is one not used as a stamp picture image.

When indicating a region not used as a stamp picture image, a user uses the input pen 32 to operate a region addition button 273 and then moves a cursor 274C to select a thickness of a pen from a thickness selection menu 274. A user can indicate a wide region at a time by selecting a pen of large thickness from the thickness selection menu 274 and indicate a small region by selecting a pen of small thickness. In addition, provided on the thickness selection menu 274 is a region indicating button 274-1 operated when a region surrounded by a locus of the input pen 32 is indicated as one not used as a stamp picture image.

Provided above the region addition button 273 of the picture image selection menu 271 is a region erasing button 272 operated when a region having been once indicated as one not used as a stamp picture image is returned again to a stamp picture image. In addition, displayed on the region erasing button 272 is a message “This pen is one for returning a region, having been made transparent, to an original one!” and displayed on the region addition button 273 is a message “This pen is one for making a region, having been painted, transparent!” Also, displayed on the respective buttons are picture images representative of images indicating the functions of the respective buttons.

Displayed on a stamp picture image displaying section 275 in real time is a stamp picture image having been created on the basis of an input onto an edited object picture image. Accordingly, a user consults a picture image displayed on the stamp picture image displaying section 275 to be able to ascertain that a stamp picture image has been created in a desired manner.

Provided on the next door on the right side is a “return” button 276 operated when creation of a stamp picture image is terminated and the screen is returned to a scribble screen. A stamp picture image having been created when the “return” button 276 is operated is kept as a stamp picture image, which can be synthesized into a fundamental picture image.

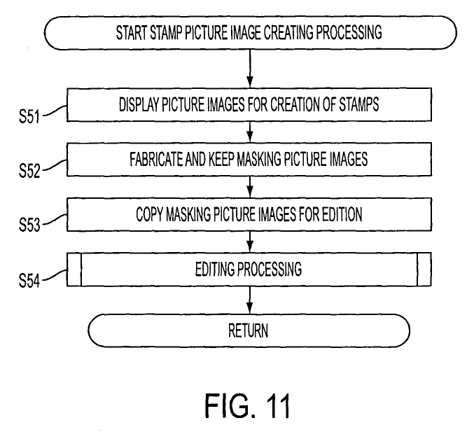

Referring again to FIG. 11, the CPU 71 forms and keeps a masking picture image for creation of stamp picture images in STEP S52. More specifically, the masking picture image generating unit 132 forms a binary masking picture image by indicating a white color (RGB (255, 255, 255)) for that region of a picture image for creation of stamps kept in the stamp creating picture image memory 131, which corresponds to a subject, and a black color (RGB (0, 0, 0)) for other regions, that is, ones corresponding to a background of a subject. An inside (a portion constituting a background of a subject) of the background panel 41 provided in the photographing space 42 is made, for example, white to readily enable extraction of a masking picture image.

In STEP S53, the CPU 71 copies a masking picture image kept in the masking picture image memory 133, into the masking picture image memory 134 to make the copied picture image a masking picture image being an object edited by the stamp creating picture image editing unit 130.

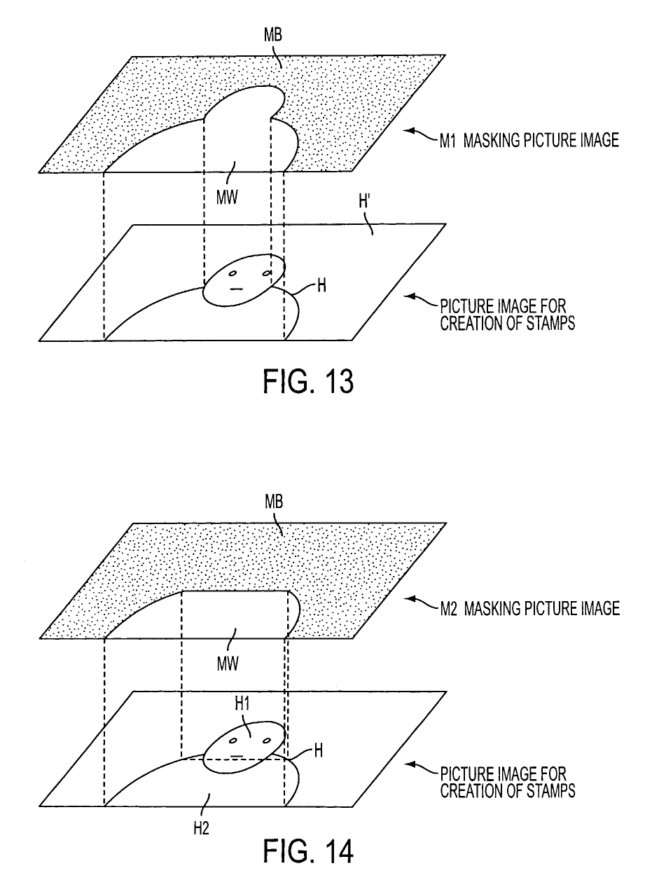

FIG. 13 is a view showing an example of a masking picture image formed by the masking picture image generating unit 132 and kept in the masking picture image memory 134.

In the example shown in FIG. 13, a region of a subject in a picture image for creation of stamps is made a region H, and the remaining region is made a region H. Accordingly, a masking picture image M1 is composed of a white region MW corresponding to the region H and a black region MB corresponding to the region H′.

As described later, when a user indicates a region by means of the input pen 32, the masking picture image M1 is edited such that the white region MW in a masking picture image M2 after edition and an overlapping region H2 of a picture image for creation of stamps imaginarily make a stamp picture image as shown in FIG. 14. in the example shown in FIG. 14, a region of a masking picture image corresponding to a region HI of a picture image for creation of stamps is added as a region MB not used as a stamp picture image.

Such edition processing of a masking picture image is carried out in STEP S54 shown in FIG. 11, and when the edition processing is terminated, a stamp picture image and a fundamental picture image are synthesized on the basis of an instruction from a user.

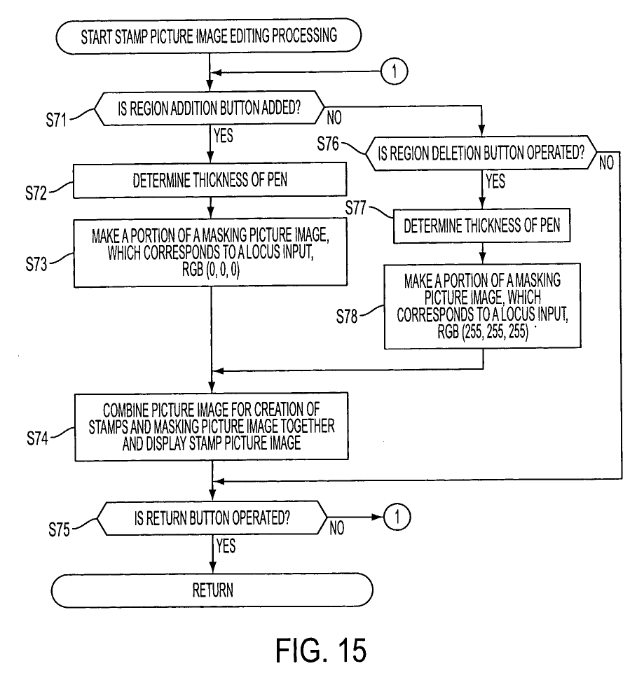

The edition processing of a stamp picture image carried out in STEP S54 shown in FIG. 11 will be described below with reference to a flowchart shown in FIG. 15.

In a state shown in FIG. 12, in which a stamp creating screen is displayed, the CPU 71 determines in STEP S71 whether the region addition button 273 is operated, and proceeds to STEP S72, in the case where it is determined that the button is operated, to determine a thickness of a pen on the basis of an input from a user. More specifically, a user uses the input pen 32 to operate the region addition button 273 in indicating a region not used as a stamp picture image (a region in which fundamental picture images are displayed when a stamp picture image is overlapped on the fundamental picture images) and selects wideness of a locus of the input pen 32 from the thickness selection menu 274. After selection of thickness, a user causes the input pen 32 to abut against an edited object picture image, and adds a region of the locus as a region not used as a stamp picture image.

In STEP S73, the CPU 71 indicates a portion of a masking picture image, which corresponds to a locus input by a user, by means of RGB (0, 0, 0) (black color). The stamp creating picture image editing unit 130 adds a black region to a masking picture image stored in the masking picture image memory 134.

In STEP S74, the CPU 71 causes the stamp creating picture image editing unit 130 to synthesize a picture image for creation of stamps, stored in the stamp creating picture image memory 128 and a masking picture image edited and stored in the masking picture image memory 134 together, and causes the stamp picture image displaying section 275 in the editing monitor 31 to display the stamp picture image thus obtained. Also, the CPU 71 causes a locus painted by a user to be displayed on a picture image displayed on the edited object picture image displaying section 151.

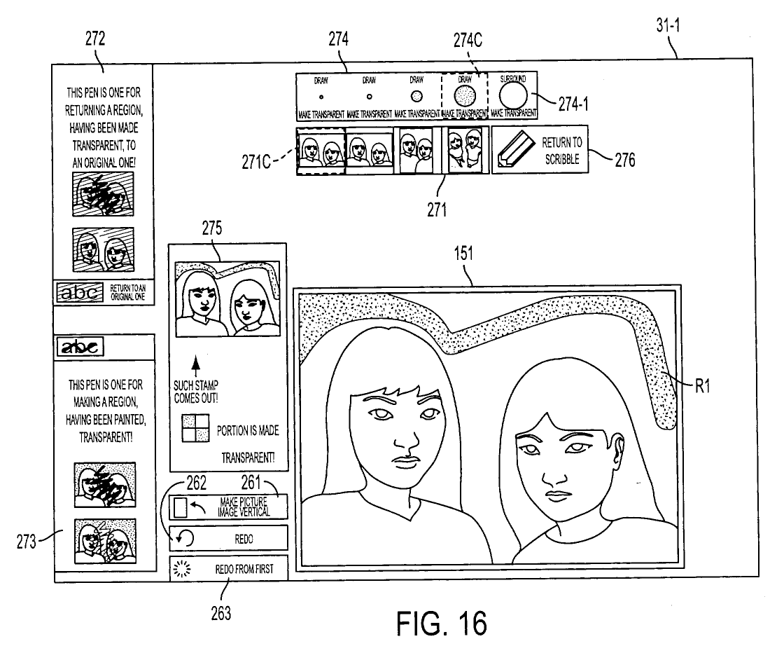

FIG. 16 is a view showing a displayed example in the case where the region addition button 273 is operated to add a region not used as a stamp picture image.

In the example shown in FIG. 16, a user operates the region addition button 273 to select a pen representative of a locus of maximum wideness from the thickness selection menu 274. Also, a region R1 in an edited object picture image is painted out by a user. As shown in the figure, a message “This region is made transparent!” is continuously displayed on the region R1 not used as a stamp picture image so that it can be ascertained at a glance that the region is one not used as a stamp picture image. Also, such region may be readily selected by flickering a border portion between a region of a subject in an edited object picture image and a background region, or by displaying the region by a color, such as red, which is easy to ascertain.

The stamp picture image displaying section 275 displays a stamp picture image at the present time, according to an input into the edited object picture image displaying section 151.

Internally, the stamp creating picture image editing unit 130 indicates that region of a masking picture image stored in the masking picture image memory 134, which corresponds to the region R1, by means of black color. In addition, while a region of a subject (white region) is beforehand extracted from a background region (black region) in a masking picture image generated by the masking picture image generating unit 132 in the example described above, a masking picture image in an initial state is made a white region in the example of FIG. 16 for the convenience of explanation (no processing for extracting a region of a subject and a background region). Accordingly, in the example shown in FIG. 16, a user must use the input pen 32 to paint out a region not used as a stamp picture image.

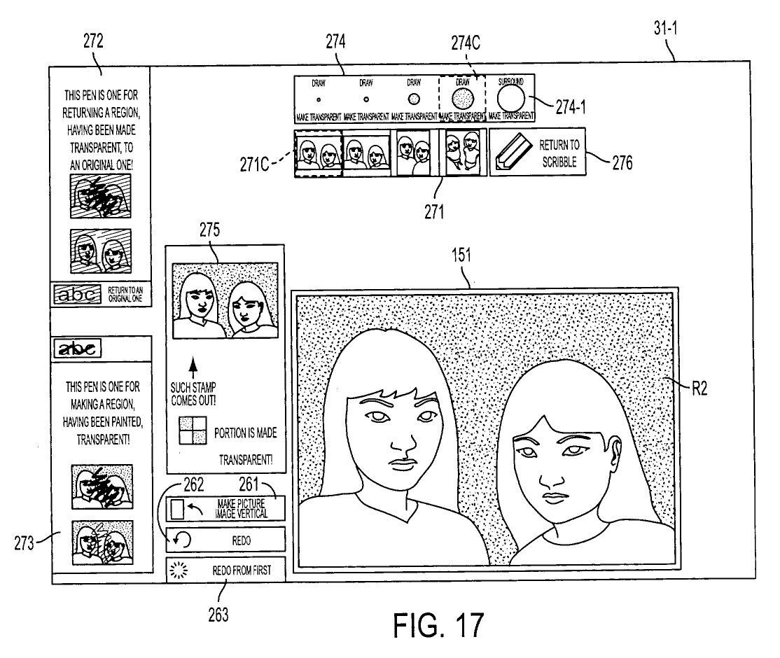

FIG. 17 is a view showing a displayed example in the case where a region (referred below to as transparent region) not used as a stamp picture image is further added in a state of an edited object picture image shown in FIG. 16.

In FIG. 17, a region R2 is indicated as a transparent region. In this manner, the input pen 32 is used to paint out to enable editing a stamp picture image, so that a user can set only one of two subjects in a stamp picture image or only faces of two subjects in a stamp picture image.

Referring again to FIG. 15, the CPU 71 determines in STEP S75 whether the “return” button 276 is operated, and returns to STEP S71, in the case where it is determined that the button is not operated, to carry out the above processing repeatedly and in the case where it is determined that the button is operated, to implement the succeeding processing in FIG. 11.

Meanwhile, in the case where it is determined in STEP S71 that the region addition button 273 is not operated, the CPU 71 proceeds to STEP S76 to determine whether the region erasing button 272 is operated.

In the case where it is determined in STEP S76 that the region erasing button 272 is not operated, the CPU 71 proceeds to STEP S75 to implement the succeeding processing and proceeds to STEP S77, in the case where it is determined that the region erasing button 272 is operated, to determine a thickness of a pen on the basis of an input from a user.

More specifically, at the time of indicating a region of a stamp picture image (a region in which a stamp picture image is displayed when a stamp picture image is overlapped on fundamental picture images) or returning a region having been once indicated as a transparent region, as a region of a stamp picture image, a user uses the input pen 32 to operate the region erasing button 272 and then selects its thickness. After selection of thickness, a user causes the input pen 32 to abut against an edited object picture image, and adds a region of the locus as a region of a stamp picture image.

In STEP S78, the CPU 71 indicates that portion of a masking picture image, which corresponds to a locus input by a user, by means of RGB (255, 255, 255) (white). The stamp creating picture image editing unit 130 adds a white region to a masking picture image stored in the masking 7 picture image memory 134.

In STEP S74, the CPU 71 causes the stamp creating picture image editing unit 130 to synthesize a picture image for creation of stamps, stored in the stamp creating picture image memory 128 and a masking picture image edited and stored in the masking picture image memory 134 together, and causes the stamp picture image displaying section 275 to display the stamp picture image thus obtained.

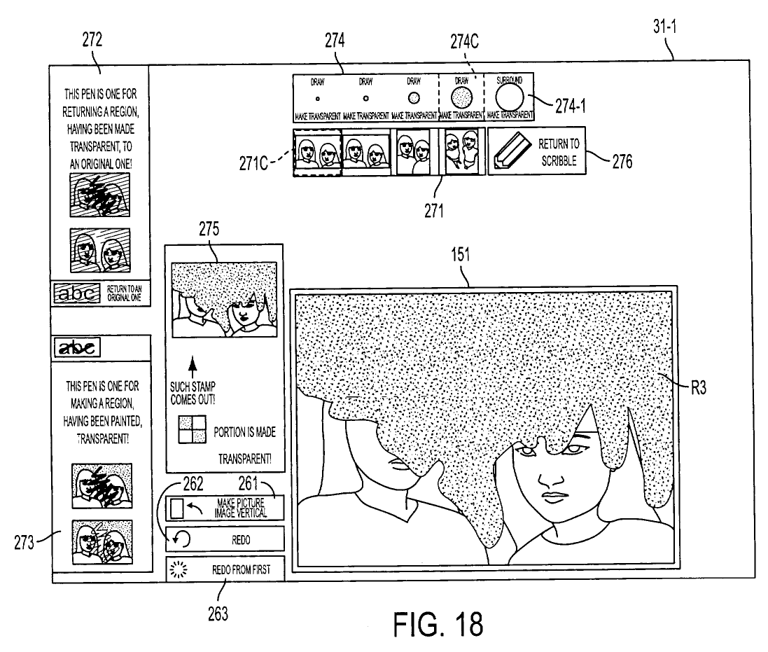

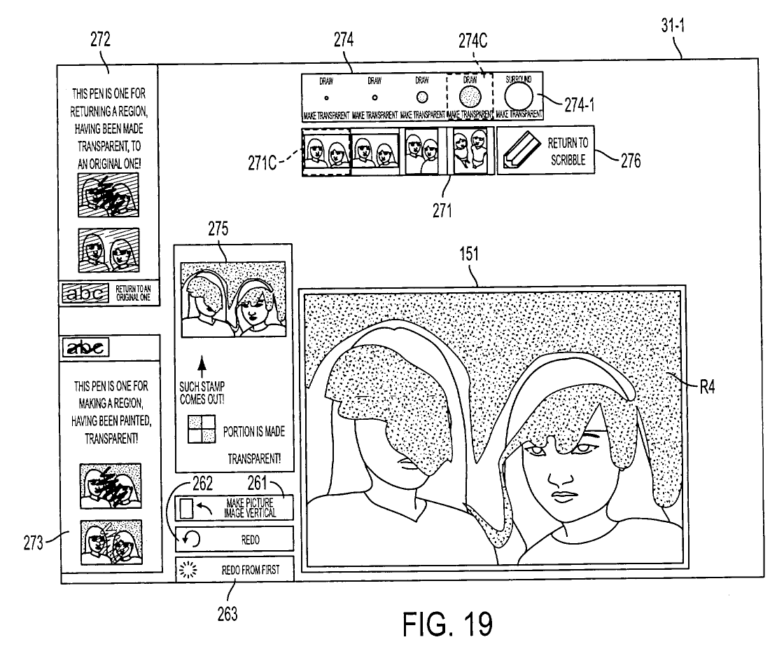

Accordingly, when a border between subjects and a background, and its neighbor are drawn by the input pen 32 in a state, in which a region R3 shown in, for example, FIG. 18 is indicated as a transparent region, the drawn region is added as a region of a stamp picture image as in an edited object picture image shown in FIG. 19. In this case, a region except a region R4 in the edited object picture image is made a region of a stamp picture image.

Returning again to an explanation for FIG. 15, the CPU 71 proceeds to STEP S75, after displaying as shown in FIG. 19 has been made, to implement the succeeding processings in FIG. 11 in the case where it is determined in STEP S75 that the “return” button 276 is operated. That is, the processing in FIG. 11 is terminated, and the processing in STEP S35 in FIG. 9 is implemented.

Such procedure is repeated to thereby enable creating a stamp picture image composed of desired regions. In addition, while a region selected by a user is made a region not used as a stamp picture image in the above, the region selected by a user may naturally be made a region used as a stamp picture image.

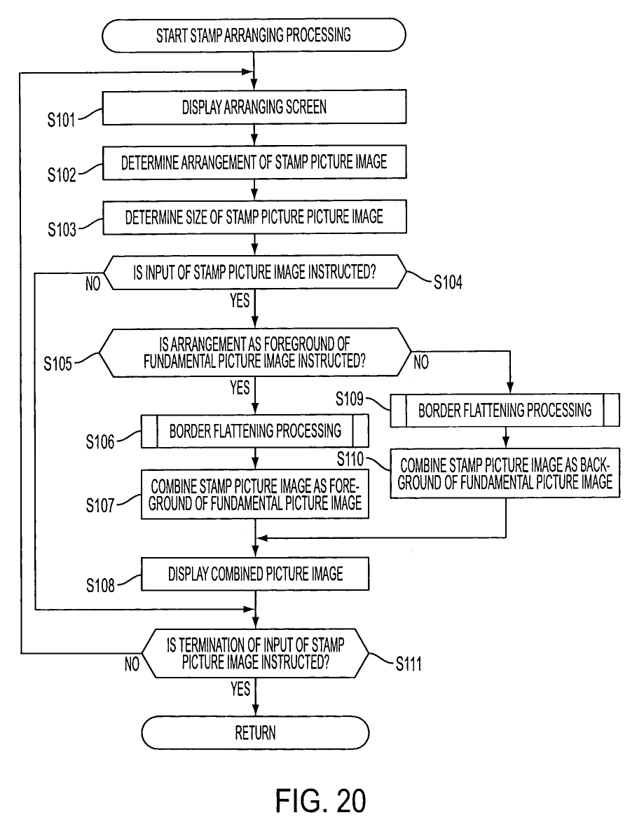

The stamp arranging processing carried out in STEP S35 shown in FIG. 9 will be described below with reference to a flowchart shown in FIG. 20.

In STEP S101, the CPU 71 causes the editing monitor 31 to display a stamp arranging screen in place of the stamp creating screen shown in FIG. 12.

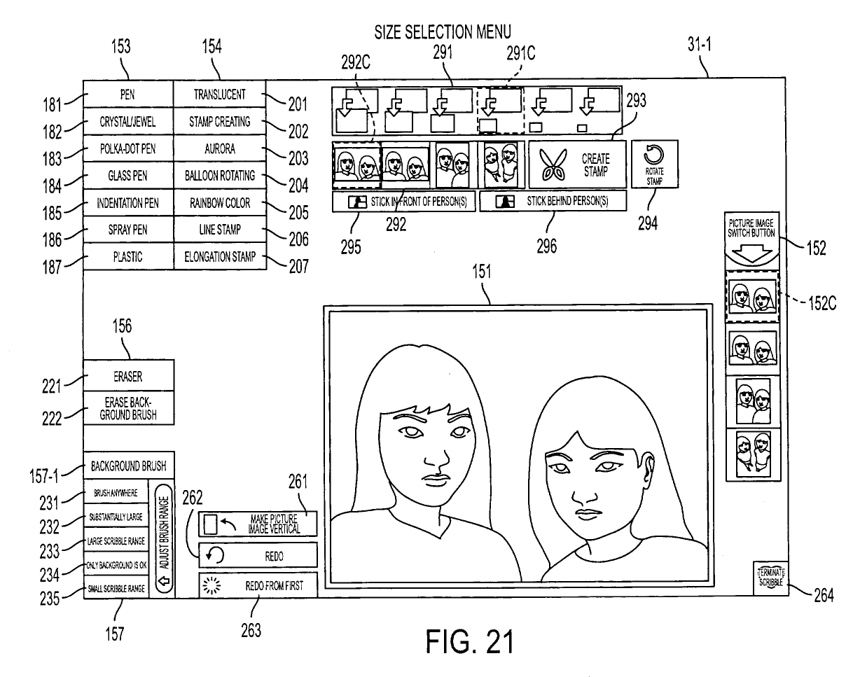

FIG. 21 is a view showing a display example of a stamp arranging screen. The same portions as those shown in FIG. 10 are denoted by the same reference numerals. In addition, the edited object picture image displaying section 151 displays a fundamental picture image.

Displayed above the stamp arranging screen is a size selection menu 291 operated in selecting a size of a stamp picture image created in the stamp creating processing. In this example, six kinds of sizes are prepared, and a user moves a cursor 291C to select a desired size.

Provided below the size selection menu 291 is a stamp picture image selection menu 292, on which a plurality of stamp picture images created in the stamp creating processing are displayed in the thumbnail representation. In this example, four kinds of stamp picture images are displayed, and a user moves a cursor 292C to select a desired stamp picture image. By carrying out the stamp creating processing described above every picture image for creation of stamps, as kept, a user can prepare a plurality of stamp picture images.

Provided on the next door on the right side of the stamp picture image selection menu 292 is a stamp creating button 293 operated in implementing the stamp picture image creating processing again, and provided on the next door on the right side of the stamp creating button 293 is a stamp rotating button 294 operated in rotating a relative position of a stamp picture image.

Provided below the stamp picture image selection menu 292 are a foreground arranging button 295 operated in arranging (arranging above a fundamental picture image) a stamp picture image as a foreground of a fundamental picture image, and a background arranging button 296 operated in arranging (arranging below a subject) a stamp picture image as a background of a subject in a fundamental picture image. A user operates these foreground arranging button 295 and background arranging button 296 to select whether a created stamp picture image should be arranged as a foreground of a fundamental picture image or a background of a subject in a fundamental picture image.

Returning again to an explanation for FIG. 20, the CPU 71 determines an arrangement of a stamp picture image, that is, whether a stamp picture image should be arranged as a foreground of a fundamental picture image or a background of a fundamental picture image, on the basis of an input from a user in STEP S102.

In STEP S103, the CPU 71 determines a size of a stamp picture image on the basis of an input from a user, and correspondingly causes the picture image reducing unit 129 to reduce a size of a picture image for creation of stamps, stored in the stamp creating picture image memory 128, and the masking picture image reducing unit 135 to reduce a size of a masking picture image stored in the masking picture image memory 134. As described above, a user moves the cursor 291C to select a size of a stamp picture image from the size selection menu 291.

The CPU 71 determines in STEP S104 whether input of a stamp picture image is instructed by a user, that is, whether the input pen 32 abuts against the editing monitor 31, and skips the processings in STEP S105 to STEP S110 in the case where input of a stamp picture image is not instructed. Meanwhile, in the case where it is determined in STEP S104 that input of a stamp picture image is instructed by a user, the CPU 71 proceeds to STEP S105 and then determines whether a stamp picture image is arranged as a foreground of a fundamental picture image.

In the case where it is determined in STEP S105 that the foreground arranging button 295 is operated and, it is instructed to arrange a stamp picture image as a foreground of a fundamental picture image, the CPU 71 proceeds to STEP S106 to cause the border correcting unit 136 to implement a border flattening processing for making a border portion inconspicuous when a stamp picture image is arranged on a fundamental picture image.

In STEP S107, the CPU 71 synthesizes a masking picture image, of which border is flattened by the border correcting unit 136, and a stamp picture image obtained by overlapping a picture image for creation of stamps, fed from the picture image reducing unit 129, by means of the edition processing unit 126, as foreground of a subject in a position on an edited object picture image, in which the input pen 32 is put. Then the CPU 71 proceeds to STEP S108 to cause the edited object picture image displaying section 151 to display a synthesized picture image thus obtained.

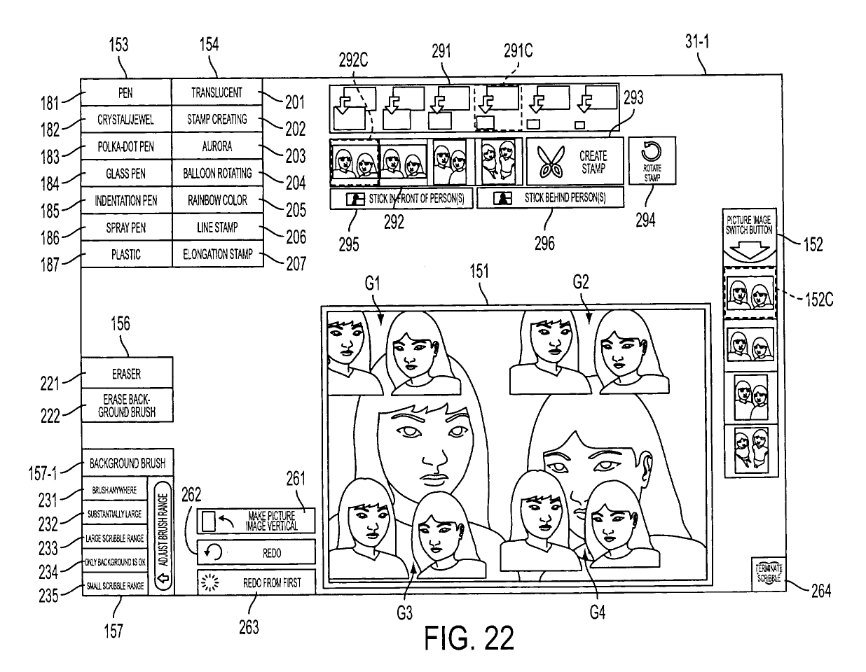

FIG. 22 is a view showing a display example of a fundamental picture image, on which a stamp picture image is arranged as a foreground.

In the example in the figure, a user arranges stamp picture images G1 to G4 as a foreground of a fundamental picture image. That is, the stamp picture images G1 to G4 are displayed in areas where the stamp picture images G1 to G4 and the fundamental picture image overlap each other. In a state, in which the stamp picture images G1 to G4 are arranged in such a manner, a user further selects various pen tools and stamp tools to apply scribble on the fundamental picture image.

Meanwhile, in the case where it is determined in STEP S105 that the background arranging button 296 is operated and it is instructed to arrange a stamp picture image as a background of a subject in a fundamental picture image, the CPU 71 proceeds to STEP S109 to cause the border correcting unit 136 to implement a border flattening processing of a subject of a fundamental picture image for making a border portion inconspicuous when a stamp picture image is arranged as a background of a fundamental picture image.

The CPU 71 causes the edition processing unit 126 in STEP S110 to extract subject regions of fundamental picture images stored the fundamental picture image memory 123 from a background to flatten border portions as extracted. The CPU 71 synthesizes a stamp picture image as a background of a subject with fundamental picture images, in which border portions of the subject regions are flattened. The CPU 71 proceeds to STEP S108 to cause the edited object picture image displaying section 151 to display a synthesized picture image thus obtained.

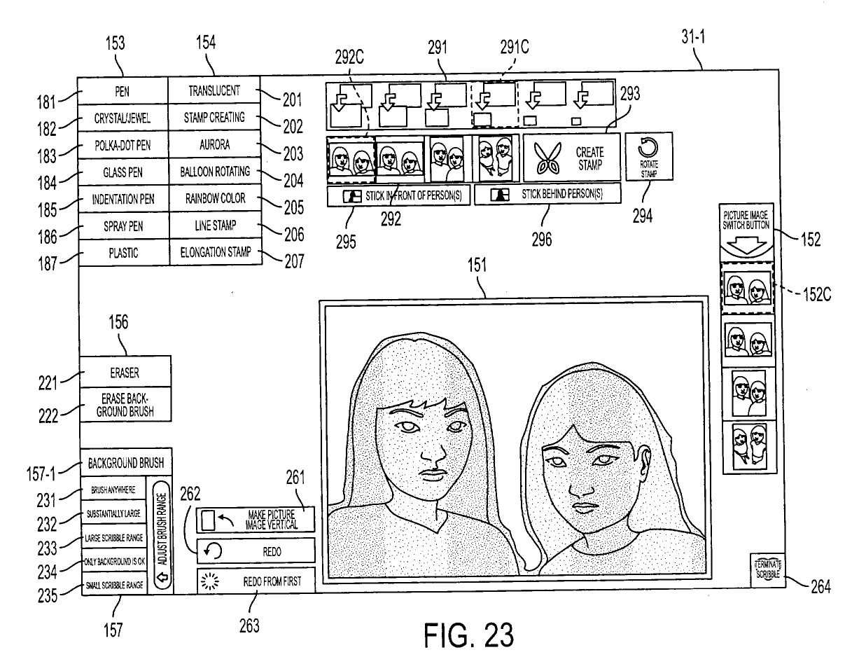

FIG. 23 is a view showing a display example, in which a stamp picture image is arranged as a background of a fundamental picture image, and as shown in the figure, a region of a subject in a fundamental picture image is displayed in, for example, blue and it is indicated that no stamp can be arranged in the region.

Also, a region in which a stamp picture image cannot be arranged is not only displayed in a single color, but also, for example, only a portion or portions in the vicinity of a border of a region, in which a stamp picture image cannot be arranged, may be flickered in a predetermined color or displayed in a color, such as red, which is easy to ascertain.

Thereby, it is possible to easily ascertain the positional relationship between a stamp picture image and a region of a subject in a fundamental picture image.

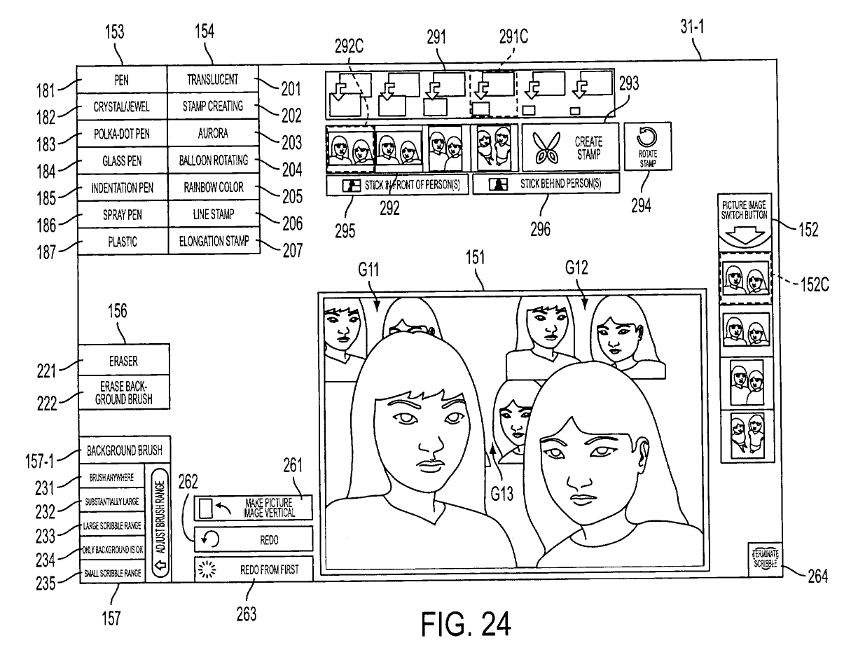

FIG. 24 is a view showing a display example in the case where a stamp picture image is arranged as a background of a subject region of a fundamental picture image in an arrangement screen as shown in FIG. 23.

As shown in the figure, a picture image of a subject is displayed in areas where stamp picture images G11 to G13 and a subject region of the fundamental picture image overlap each other, and the stamp picture images are hidden by the subject region. In a state in which the stamp picture images G11 to G13 are arranged in such a manner, a user further uses various pen tools and stamp tools to be able to apply scribble.

When the screens as shown in FIGS. 22 and 24 are displayed, the CPU 71 proceeds to STEP S111 to determine whether it is instructed to terminate input of a stamp picture image, and returns to STEP S101 in the case where it is not instructed, thus implementing the above processing repeatedly.

Meanwhile, in the case where other pens are selected and it is determined in STEP S111 that it is instructed to terminate input of a stamp picture image, the CPU 71 terminates the arranging processing for a stamp picture image and implements the succeeding processing in FIG. 9.

That is, when it is instructed to terminate the scribble processing, the CPU 71 prints a fundamental picture image, on which a stamp picture image is arranged as shown in, for example, FIG. 22 or FIG. 24, on a seal paper 91 and terminates the processing.

In addition, while a stamp picture image as a background or foreground of a subject and a fundamental picture image in the above procedure are synthesized, only a stamp picture image created may be arranged in a desired position and may be enabled to be printed. As described above, a user can create a plurality of stamp picture images, which makes it possible to form a seal paper, on which a picture image with only the plurality of stamp picture images arranged in different positions is printed.

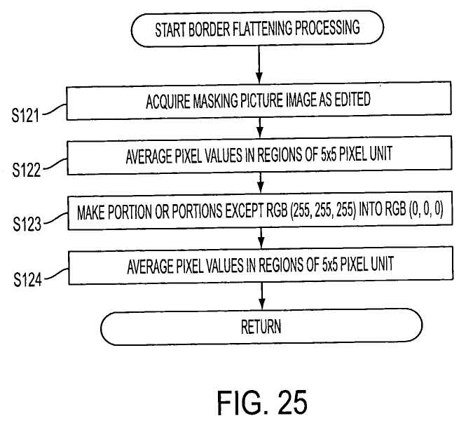

The border flattening processing of a stamp picture image carried out in STEP S106 shown in FIG. 20 will be described below with reference to a flowchart shown in FIG. 25.

In STEP S121, the border correcting unit 136 acquires a stamp picture image having been edited. More specifically, the masking picture image reducing unit 135 reads a masking picture image having been edited and stored in the masking picture image memory 134 and reduces the masking picture image to a predetermined size, then outputting the same to the border correcting unit 136.

In STEP S122, the border correcting unit 136 averages pixel values in regions of a masking picture image in, for example, a 5×5 pixel unit (a region composed of five pixels in a longitudinal direction and five pixels in a transverse direction). That is, the border correcting unit 136 extracts respective pixel values of 5×5 pixels and calculates an average of the extracted pixel values. Then the border correcting unit 136 indicates respective pixel values in regions of 5×5 pixels by means of the calculated average.

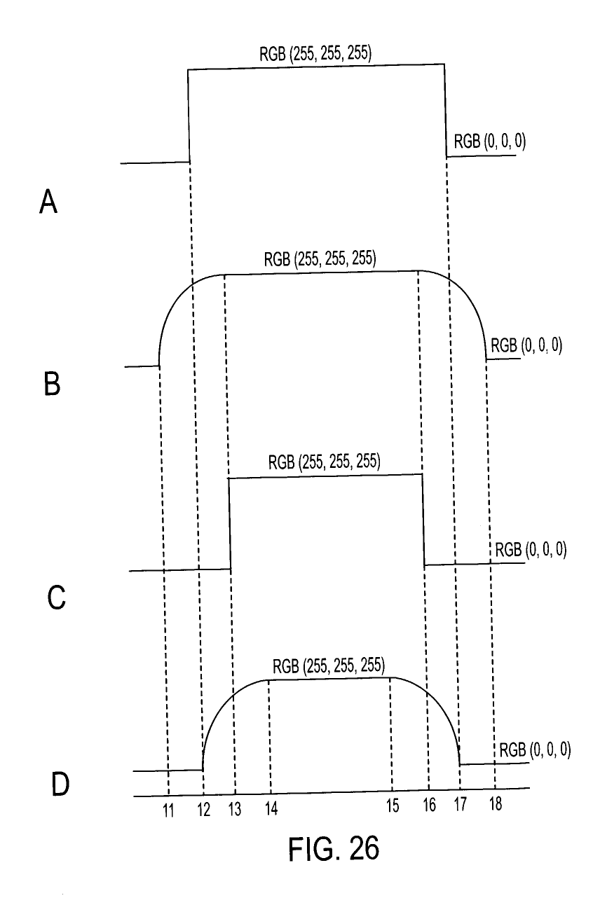

FIG. 26 is a view showing an example of a cross section of a masking picture image. In FIG. 26, a longitudinal direction represents pixel value, and a transverse direction represents coordinate of a masking picture image.

For example, in the case where a masking picture image having a cross section A is acquired, the border correcting unit 136 averages pixel values in regions of a masking picture image of a cross section A in, for example, 5×5 pixel unit to generate a masking picture image of a cross section B.

Thereby, an edge in a position 12 in the cross section A is rounded between positions 11 to 13 as shown in a cross section B, that is, corrected such that gray color is sequentially increased in strength in a direction from the position 13 toward the position 11.

Also, an edge in a position 17 in the cross section A is corrected such that gray color is sequentially increased in strength in a direction from a position 15 toward a position 17.

Referring again to FIG. 25, the border correcting unit 136 makes a portion or portions except RGB (255, 255, 255) into RGB (0, 0, 0) in STEP S123, and again makes a masking picture image a binary picture image composed of RGB (255, 255, 255) and RGB (0, 0, 0).

For example, in the case where the cross section B in FIG. 26 is acquired in STEP S122, the border correcting unit 136 makes a portion or portions except RGB (255, 255, 255), that is, a portion between the position 13 and the position 11 and a portion between the position 16 and the position 18 into RGB (0, 0, 0) to generate a masking picture image having a cross section C.

In STEP S124, the border correcting unit 136 averages pixel values in regions of, for example, 5×5 pixel unit to generate a gray region in a border portion of a masking picture image.

In the case where a masking picture image having a cross section C is obtained in, for example, STEP S123, the border correcting unit 136 averages pixel values in regions of 5×5 pixel unit to generate a masking picture image having a cross section D.

Thereby, edges, respectively disposed in position 13 and position 16 in the cross section C are corrected such that gray color is sequentially increased in strength in a direction from a position 14 toward the position 12 and in a direction from the position 15 toward the position 17 as shown in the cross section D. That is, gray regions are generated inside (toward the position 16) the position 12, in which an edge of a masking picture image having the edited cross section A is disposed, and inside (toward the position 13) the position 17, in which an edge of a masking picture image having the edited cross section A is disposed, so that border portions of the masking picture image are flattened.

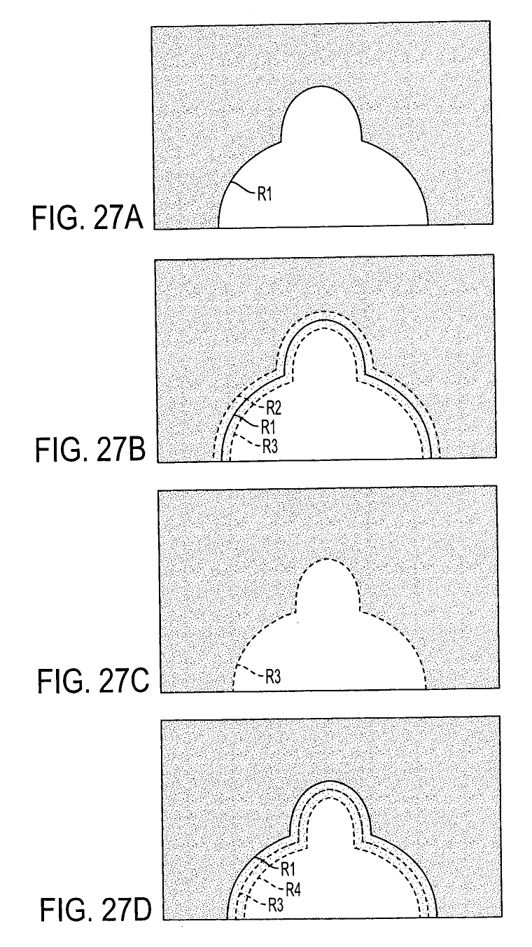

FIGS. 27A to 27D are views showing an example of a masking picture image, of which border portions are flattened.

In the case where a masking picture image having an outline R1 is acquired as shown in FIG. 27A, the border correcting unit 136 averages pixel values of the masking picture image every region of 5×5 pixel unit to generate a masking picture image as shown in FIG. 27B, in which a region between an outline R2 and an outline R3 is made gray (the processing in STEP S122 in FIG. 25). In addition, while the whole gray region is shown as being in the same strength in FIGS. 27, the region is actually displayed to be gradually increased in strength between a white region and a black region.

The border correcting unit 136 subsequently indicates values of pixels except RGB (255, 255, 255) by means of RGB (0, 0, 0) to generate a masking picture image shown in FIG. 27C and making an outline R3 a border between a black region and a white region (the processing in STEP S123 in FIG. 25).

Then the border correcting unit 136 averages pixel values of a masking picture image shown in FIG. 27C in a region of 5×5 pixel unit to generate a masking picture image shown in FIG. 27D and having a gray region between an outline R1 and an outline R4 (the processing in STEP S124 in FIG. 25).

In this manner, a picture image for creation of stamps and the masking picture image, of which border is flattened, overlap each other, whereby a stamp picture image with a border thereof blurred is generated and a border portion between the stamp picture image and a fundamental picture image becomes inconspicuous even when the stamp picture image is arranged on the fundamental picture image. For example, in the case where a fundamental picture image and a stamp picture image are synthesized without performing such flattening processing as described above, a border portion there between becomes conspicuous to provide a bad-looking picture image.

While averaging of pixel values in regions of 5×5 pixel unit is made with respect to all masking picture images irrespective of sizes of stamp picture images selected in the above processing, unit of regions being averaged may be modified according to sizes of stamp picture images selected. For example, in the case where a small size such as first or second size from the right in the size selection menu 291 shown in FIG. 21 is indicated, only an outline portion of a masking picture image can be appropriately averaged by averaging pixel values in regions of 3×3 pixel unit.

While an explanation has been given to the processing of flattening a border portion of a stamp picture image in the above, the processing of flattening a border portion of a fundamental picture image is performed in the same manner in the case where a stamp picture image is arranged as a background of a region of a subject. That is, averaging of pixel values or the like is made for a border portion between a region of a subject in a fundamental picture image stored in the fundamental picture image memory 123 and a background region. Thereby, even in the case where a stamp picture image is arranged as a background of a region of a subject in a fundamental picture image, a border there between can be made inconspicuous and a good-looking picture image can be printed.

While the processing implemented in STEP S54 shown in FIG. 11 has been explained by taking as an example the processing, in which a region of a stamp picture image is edited by painting-out with the input pen 32, in FIG. 15, a user operates the region indicating button 274-1 provided on the thickness selection menu 274 in FIG. 12 to surround a predetermined region, thus enabling indicating a region not used as a stamp picture image.

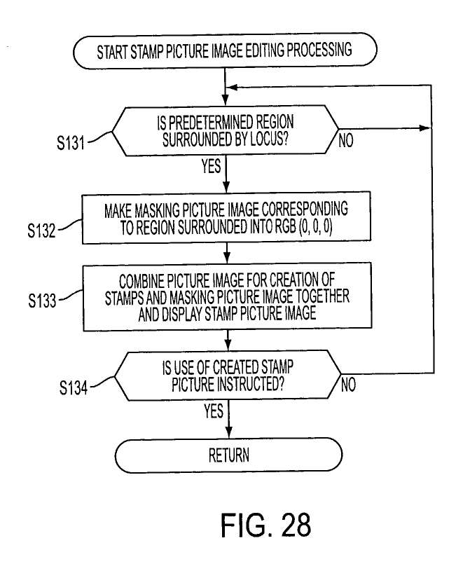

Subsequently, an explanation will be given to the editing processing of indicating a region not used as a stamp picture image by operating the region indicating button 274-1 to surround a predetermined region with reference to a flowchart shown in FIG. 28. In addition, a message “surround and making transparent” is displayed in the region indicating button 274-1.

When, for example, the region indicating button 274-1 shown in FIG. 12 is operated, the CPU 71 determines in STEP S131 whether a predetermined region of a picture image to be edited is surrounded by a locus of the input pen 32, and waits until it is determined that the predetermined region has been surrounded.

In the case where it is determined in STEP S131 that the predetermined region of the picture image to be edited has been surrounded, the CPU 71 proceeds to STEP S132 to indicate pixel values of a masking picture image stored in the masking picture image memory 134 and corresponding to a region or regions surrounded by the input pen 32, by means of RGB (0, 0, 0).

In STEP S133, the CPU 71 causes the stamp creating picture image editing unit 130 to synthesize a masking picture image edited in STEP S132 and a picture image for creation of stamps, stored in the stamp creating picture image memory 128, and causes the stamp picture image displaying section 275 to display a stamp picture image at the present time. Accordingly, a picture image to be edited, shown in, for example, FIG. 12 is displayed, and when a region of a face of a subject is surrounded, the stamp picture image displaying section 275 displays a stamp picture image, of which region is made transparent.

In the case where it is determined in STEP S134 whether the use of the created stamp picture image is instructed and it is determined that such use is not instructed, the CPU 71 returns to STEP S131 to implement the succeeding processing repeatedly. Meanwhile, in the case where it is determined in STEP S134 that the use of the created stamp picture image is instructed, the CPU 71 implements the succeeding processing in FIG. 11. That is, such processing as flattening or the like is applied on the created stamp picture image, and then the stamp picture image is arranged as a foreground of a fundamental picture image.

A user can create a desired stamp picture image with such processing of course, a region surrounded by a user may be used a stamp picture image.

Also, instead of indicating a region by means of the input pen 32, a stamp picture image may be edited on the basis of luminance set by a user and setting on color.

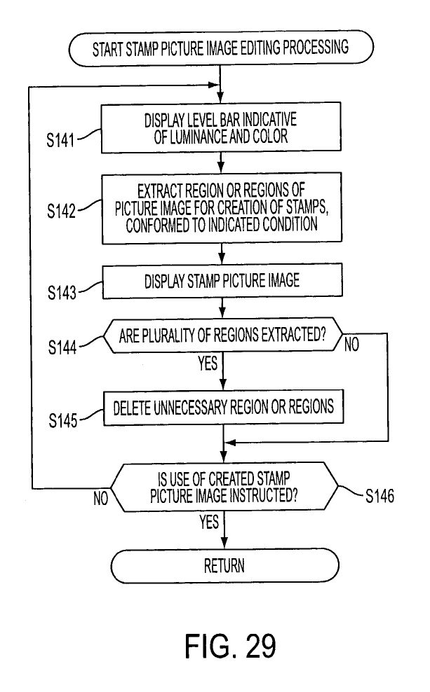

Subsequently, an explanation will be given to the processing of editing a stamp picture image on the basis of setting on luminance and color with reference to a flowchart shown in FIG. 29.

In STEP S141, the CPU 71 causes the editing monitor 31 to display a level bar as an operating button operated in making a predetermined setting with respect to color such as hue, chroma, brightness, or RGB values in addition to luminance.

When luminance and color are set by a user, the CPU 71 in STEP S142 extracts a region or regions conformed to an indicated condition in a picture image for creation of stamps, stored in the stamp creating picture image memory 128, and proceeds to STEP S143 to display a stamp picture image composed of extracted region or regions on the stamp picture image displaying section 275.

In the case where it is determined in STEP S144 whether a plurality of regions are extracted and it is determined that the plurality of regions are extracted, the CPU 71 proceeds to STEP S145 to erase unnecessary region or regions on the basis of an instruction from a user. In addition, in the case where it is determined in STEP S144 that the plurality of regions are not extracted, the processing in STEP S145 is skipped.

In the case where it is determined in STEP S146 whether the use of extracted region or regions as a stamp picture image is instructed by a user and it is determined that such use is not instructed, the CPU 71 returns to STEP S141 to implement the above processings repeatedly. Meanwhile, in the case where it is determined in STEP S146 that the use of extracted region or regions as a stamp picture image is instructed by a user, the CPU 71 terminates the processing. That is, after flattening of a border portion is made, the extracted region or regions are arranged in a predetermined position or positions on a fundamental picture image.

While a stamp picture image having been subjected to flattening of a border portion is synthesized with a fundamental picture image in the above processing, a user may adjust brightness, transmittance, color or the like, of the created stamp picture image before, for example, the image is synthesized with a fundamental picture image.

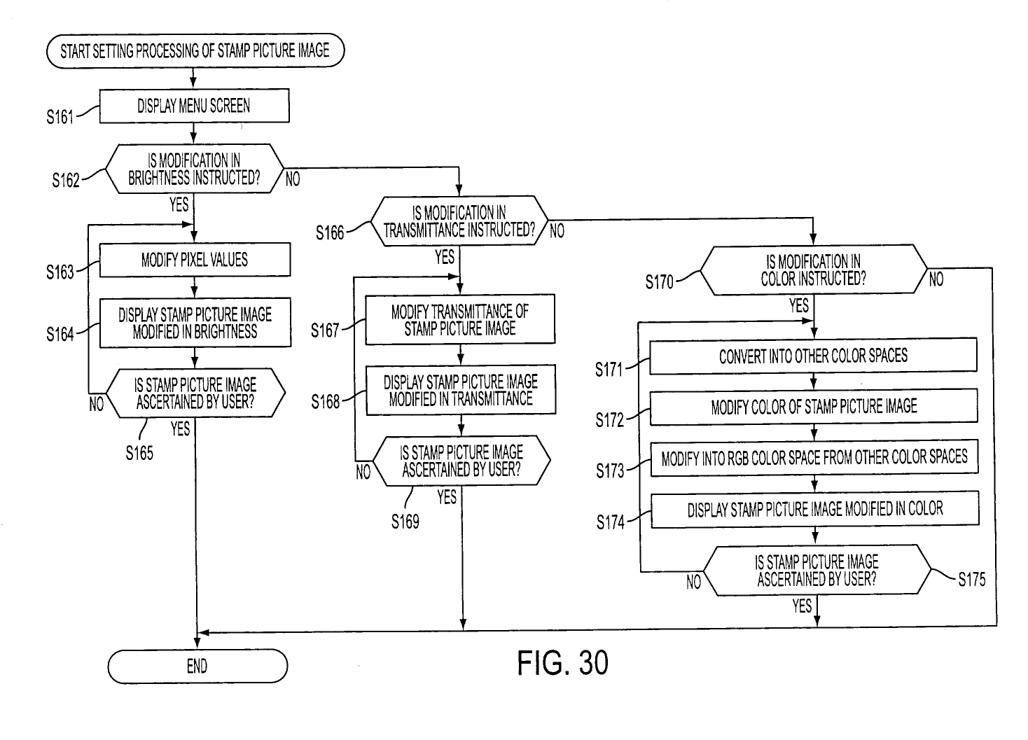

Subsequently, an explanation will be given to the processing of modifying brightness, transmittance, color of a stamp picture image with reference to a flowchart shown in FIG. 30.

In STEP S161, the CPU 71 causes the editing monitor 31 to display a menu for selection of an element being modified for a stamp picture image, and the CPU 71 proceeds to STEP S162 to determine whether a user instructs modification of brightness of a stamp picture image.

In the case where it is determined in STEP S162 that modification of brightness of a stamp picture image is instructed, the CPU 71 proceeds to STEP S163 to modify pixel values of respective pixels in the stamp picture image. For example, the CPU 71 modifies brightness by adding a predetermined gain as preset to RGB values of respective pixels in the stamp picture image to add a predetermined offset to values obtained.

In STEP S164, the CPU 71 causes the stamp picture image displaying section 275 to display a stamp picture image modified in brightness to present the same to a user. A user ascertains the stamp picture image displayed on the stamp picture image displaying section 275 and operates a predetermined affirmation button displayed on the editing monitor 31 when the stamp picture image is a desired one.

In the case where it is determined in STEP S165 whether the stamp picture image modified in brightness is ascertained by a user and it is determined that the stamp picture image is not ascertained, the CPU 71 returns to STEP S163 to implement the above processings repeatedly. That is, gain and offset values are set likewise and pixel values are modified.

Also, in the case where it is determined in STEP S165 that the affirmation button is operated by a user and the stamp picture image modified in brightness is ascertained, the CPU 71 terminates the processing. Whether the created stamp picture image is arranged as a foreground of a fundamental picture image or a background of a region of a subject in a fundamental picture image is selected, and the created stamp picture image is arranged in a predetermined position.

Meanwhile, in the case where it is determined in STEP S162 that modification in brightness is not instructed, the CPU 71 proceeds to STEP S166 and subsequently determines whether modification in transmittance is instructed. Through modification in transmittance, a user can create a translucent stamp picture image, for example, a picture image, in which a fundamental picture image transmits from below a stamp picture image to be able to be ascertained, by arranging the created stamp picture image as a foreground of the fundamental picture image.

In the case where it is determined in STEP S166 that modification in transmittance is instructed, the CPU 71 proceeds to STEP SI 67 to modify transmittance of a stamp picture image on the basis of an input from a user. In STEP S168, the CPU 71 displays a translucent stamp picture image obtained by modification in transmittance and presents the same to a user. In addition, like the above-mentioned case, there is displayed an affirmation button operated in ascertaining the created stamp picture image.

In the case where it is determined in STEP S169 that the translucent stamp picture image thus created is not ascertained by a user, the CPU 71 returns to STEP S167 to implement the above processings repeatedly, and on the other hand terminates the processing in the case where it is determined that the translucent stamp picture image is ascertained by a user. Thereafter, correction of a border portion of the stamp picture image is made, and the picture image is synthesized into a fundamental picture image.

Meanwhile, in the case where it is determined in STEP S160 that modification in transmittance is not instructed, the CPU 71 proceeds to STEP S170 and subsequently determines whether modification in color is instructed. In the case where it is determined in STEP S170 that modification in color is not instructed, the CPU 71 terminates the processing, and on the other hand proceeds to STEP S171 in the case where it is determined that modification in color is instructed.

In STEP S171, the CPU 71 converts colors of respective pixels of the stamp picture image into other color spaces. For example, in the case where the stamp picture image is represented by RGB space, the CPU 71 converts colors of respective pixels into HSB color spaces composed of H (hue), S (chroma) and B (brightness), and Lab color spaces composed of L (brightness), a (mixing ratio of green and magenta (chromaticity)), and b (mixing ratio of blue and yellow (chromaticity)). Then the CPU 71 proceeds to STEP S172 to modify values such as hue and chroma to modify a color of the stamp picture image in the modified color space.

By modifying the color space into HSB color spaces, it suffices to modify only a value of chroma when it is desired to modify, for example, only clarity, so that colors can be modified more directly and simply than in the case of RGB space. That is, in the case where clarity should be modified in RGB space, it is necessary to modify respective values of RGB.

In STEP S173, the CPU 71 returns color spaces of colors of the stamp picture image to RGB space so as to have a user ascertaining the stamp picture image modified in color.

In STEP S174, the CPU 71 causes the editing monitor 31 to display the stamp picture image modified in color together with an affirmation button operated in using the stamp picture image to present the same to a user. In the case where it is determined in STEP S175 whether the stamp picture image modified in color is ascertained by a user and it is determined that the stamp picture image is not ascertained, the CPU 71 returns to STEP S171 to implement the above processings repeatedly. Meanwhile, in the case where it is determined in STEP S175 that the stamp picture image modified in color is ascertained by a user, the CPU 71 terminates the processing. The stamp picture image modified in color has its border portion corrected, and is synthesized into a fundamental picture image.

The above processings can further edit the stamp picture image created with a region or regions being indicated, according to preference.

While edition of a stamp picture image in the edition processing has been mainly described above, an explanation will be given below to an aurora stamp used when the “aurora stamp” button 203 shown in FIG. 10 is operated, and an elongation stamp used when the “elongation stamp” button 207 is operated, in the edition processing in the picture image printing apparatus 1. These aurora stamp and elongation stamp are used in the processing of STEP S33 shown in FIG. 9.

The aurora stamp is a stamp tool, which is sequentially changed in color according to a period of time, during which the input pen 32 is caused to abut against an edited object picture image (pen down), and which permits a stamp picture image (bit-map picture image) of a color in a timing of pen-up to be input into the edited object picture image. Various picture images such as heart-shaped or flower-shaped are beforehand prepared as a stamp picture image.

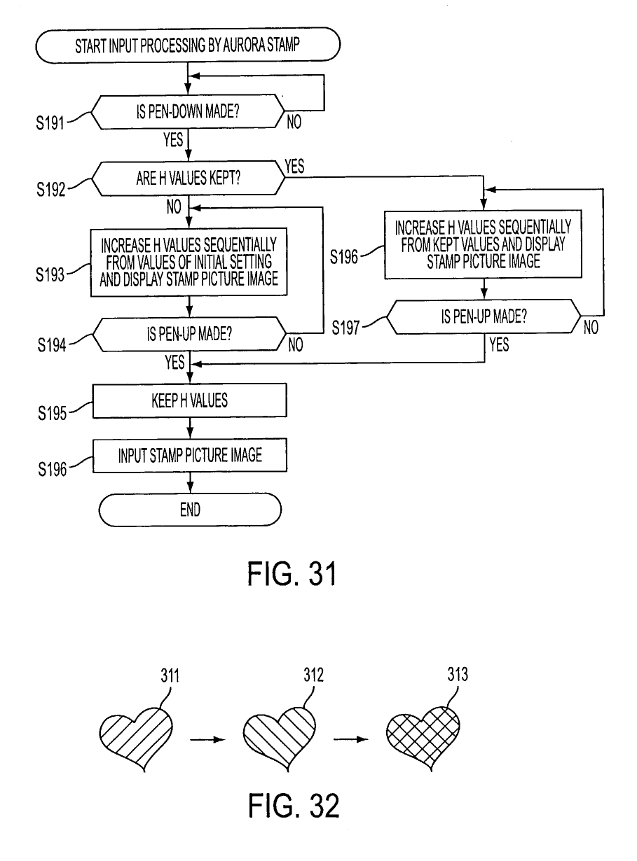

FIG. 31 is a flowchart illustrating the processing, in which a picture image is input into an edited object picture image by means of an aurora stamp.

When the “aurora stamp” button 203 is operated by the input pen 32, the CPU 71 determines in STEP S191 whether the input pen 32 touches (pen-down) an edited object picture image (the touch panel 64), and waits until it is determined that the input pen makes pen down.

In the case where it is determined in STEP S191 that the input pen 32 makes pen-down, the CPU 71 proceeds to STEP S192 to determine whether hue values (H values) of a stamp picture image selected are kept. That is, when the input pen 32 makes pen-up, hue values of a stamp picture image in that timing are kept, and when the input pen makes pen-down again, hue values are sequentially increased from the values kept so that the stamp picture image is changed in color.

In the case where it is determined in STEP S192 that the hue values are not kept, the CPU 71 proceeds to STEP S193 to sequentially increase the hue values from values of initial setting to change the stamp picture image in color. The processing, in which hue values are increased, is implemented until it is determined in STEP S194 that the input pen makes pen-up.

In the case where it is determined in STEP S194 that the input pen 32 makes pen-up (separate) relative to an edited object picture image, the CPU 71 proceeds to STEP S195 to keep hue values. In STEP S196, the CPU 71 inputs a stamp picture image, of which color is in a timing of pen-up, into an edited object picture image.

Meanwhile, in the case where it is determined in STEP S192 that hue values are kept, the CPU 71 proceeds to STEP S196 to sequentially increase the hue values from the kept values to display a stamp picture image.

The CPU 71 determines in STEP S197 whether the input pen 32 makes pen-up, and returns to STEP S196 until it is determined that the input pen makes pen-up, thus increasing the hue values to change a stamp picture image in color.

In the case where it is determined in STEP S197 that the input pen 32 makes pen-up, the CPU 71 proceeds to STEP S195 to keep the hue values, and further proceeds to STEP S196 to input a stamp picture image, of which hue value is in a timing of pen-up, into an edited object picture image.

FIG. 32 is a view showing an example, in which a stamp picture image input by an aurora stamp tool is changed in color.

In the example, in which a heart-shaped picture image is selected as a stamp picture image, shown in FIG. 32, a color of a stamp picture image 311 is changed to a color of a stamp picture image 312 according to a period of time, during which a user causes the input pen 32 to make pen-down on an edited object picture image, and further changed to a color of a stamp picture image 313.

Accordingly, when a user causes pen-up in a state, in which the stamp picture image 312 is displayed, a hue value of the stamp picture image 312 is kept. When the input pen 32 again makes pen-down in the same or different position on an edited object picture image, a hue value is sequentially increased from the kept value, so that a color of the stamp picture image 312 is changed into a color of the stamp picture image 313.

By virtue of the above processings, a user selects a desired picture image and can input a picture image of a desired color in a position of pen-down according to a period of time, during which the input pen 32 makes pen-down in a predetermined position on an edited object picture image. That is, it is possible to select an optimum color for a fundamental picture image in a state in which a stamp picture image is actually arranged on the edited object picture image.

In addition, while a user operates the “aurora stamp” button 203 and selects a desired one from stamp picture images prepared beforehand, a color of a stamp picture image created in a manner described above (a stamp picture image kept in the photographing processing and created through edition of a region or regions or the like) may be changeable according to a period of time, during which pen-down is made.

An explanation will be given below to the processing in the case where the “elongation stamp” button 207 is operated.

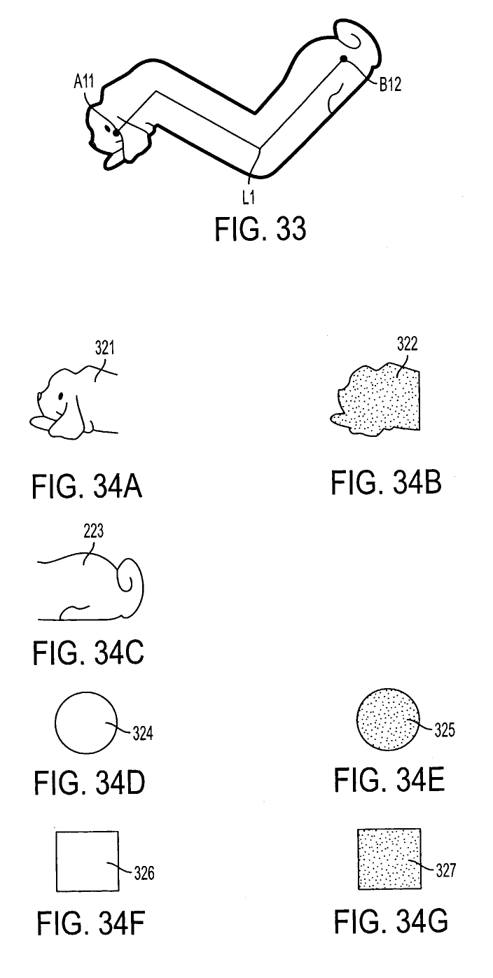

FIG. 33 is a view showing an example of a stamp picture image (referred suitably below to as elongation stamp picture image) input by the operation of the “elongation stamp” button 207. In addition, while the stamp picture image is actually displayed on an edited object picture image, only a stamp picture image as input is shown in FIG. 33 for the convenience of explanation.

In the case where pen-down is made in a position A11 on an edited object picture image, for example, in a state, in which the “elongation stamp” button 207 is operated by a user and a stamp picture image representative a dog is selected from a menu displayed, and the input pen 32 is moved to a position B12 along a locus L1 in such state, a stamp picture image representative a dog having an elongated trunk as shown in FIG. 33 is displayed. That is, a picture image of a dog's head is input in the pen-down position A11, a picture image of the trunk is input along a locus of the input pen 32, and further a picture image of a dog's tail is input in a pen-up position B12.

For example, a menu displayed when the “elongation stamp” button 207 is operated prepares various kinds of stamp picture images, such as a picture image representative of a giraffe or a picture image representative of a human, in addition to a picture image representative of a dog. For example, in the case where a picture image representative of a giraffe or a human is selected to be input onto an edited object picture image, a stamp picture image, in which a neck is elongated along a locus of the input, is displayed.

FIGS. 34A to 34G are views showing an example of bit-map picture images, which are beforehand prepared in order to display the picture image of a dog shown in FIG. 33.

FIG. 34A shows a tip end pattern picture image 321 input in a pen-down position, and FIG. 34B shows a tip end edge picture image 322 disposed below the tip end pattern picture image 321 to represent an outline of the tip end pattern picture image 321. That is, the tip end edge picture image 322 is first drawn in the pen-down position and the tip end pattern picture image 321 is drawn thereon. Thereby, the picture image of a dog's head shown in FIG. 33 is displayed.

FIG. 34C shows an example of a trailing end picture image 323 input in a pen-up position. FIG. 34D shows an example of an interpolating pattern picture image 324 interpolating between the tip end pattern picture image 321 and the trailing end picture image 323, and FIG. 34E shows an interpolating edge picture image 325 disposed below the interpolating pattern picture image 324 to represent an outline of the interpolating pattern picture image 324.

FIG. 34F shows an example of an interpolating pattern picture image 326 interpolating between the tip end pattern picture image 321 and the trailing end picture image 323, and FIG. 34G shows an interpolating edge picture image 327 disposed below the interpolating pattern picture image 326 to represent an outline of the interpolating pattern picture image 326.

The tip end pattern picture image, tip end edge picture image, trailing end picture image, interpolating pattern picture image, and the interpolating edge picture image 325 as shown in FIGS. 34A to 34G are prepared every stamp picture image prepared on the menu.

Subsequently, an explanation will be given to the processing of inputting a picture image by means of the elongation stamp with reference to a flowchart shown in FIG. 35.

When the “elongation stamp” button 207 is operated and a predetermined picture image is selected from the menu, the CPU 71 determines in STEP S211 whether the input pen 32 makes pen-down on an edited object picture image, and waits until pen-down is made.

In the case where it is determined in STEP S211 that the input pen 32 makes pen-down, the CPU 71 proceeds to STEP S212 to draw a tip end edge picture image in a position where pen-down is made. Having drawn the tip end edge picture image, the CPU 71 proceeds to STEP S213 to draw a tip end pattern picture image overlapping the tip end edge picture image.

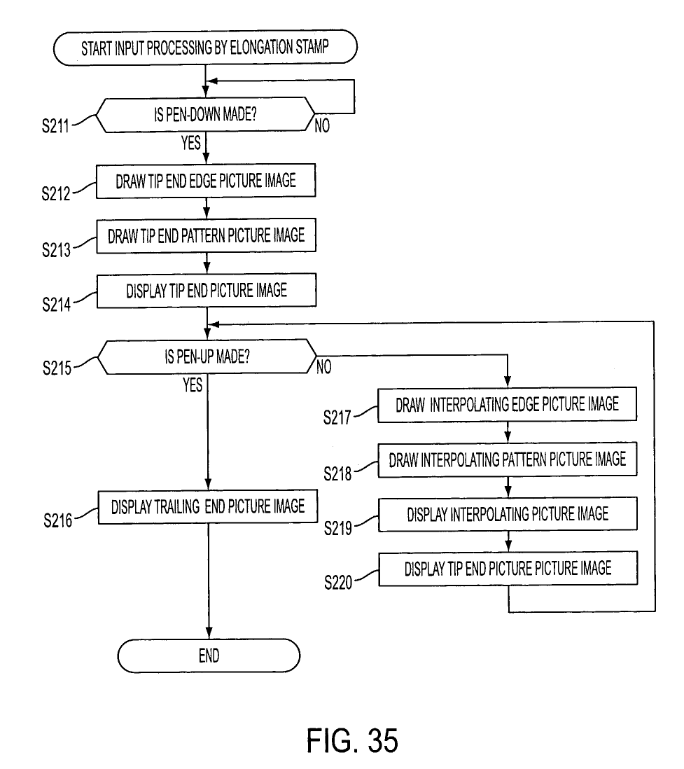

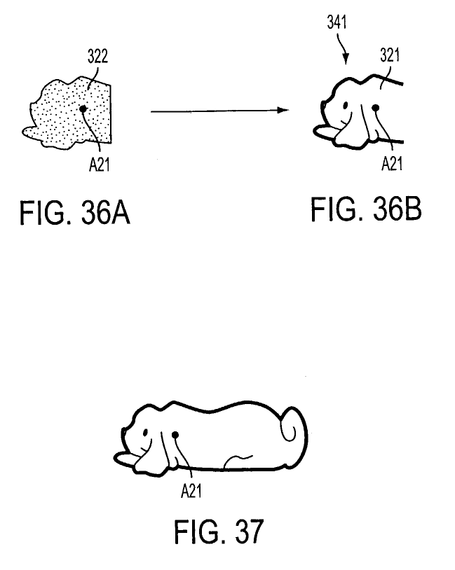

FIGS. 36A and 36B are views showing an example of a picture image drawn in a position A21 where pen-down is made. In addition, a picture image representative of a dog is selected from a picture image selection menu in the example.

When pen-down is made in the position A21 on an edited object picture image as shown in FIG. 36A, the tip end edge picture image 322 shown in FIG. 34B is drawn there. As shown in FIG. 36B, the tip end pattern picture image 321 shown in FIG. 34A is drawn overlapping the tip end edge picture image 322 and so a tip end picture image 341 is generated.

In the case where it is determined in STEP S215 whether the input pen 32 makes pen-up and it is determined that pen-up is made, the CPU 71 proceeds to STEP S216 to display a trailing end picture image in a position where pen-up is made, thus terminating the processing.

For example, in the case where pen-up is made in the position A21 shown in FIGS. 36A and 36B (in the case where pen-up is made immediately after pen-down has been made), the trailing end picture image 323 is drawn on the next door on the right side of the tip end picture image 341 as shown in FIG. 37 and so a picture image representative of a dog is displayed as a whole.

Meanwhile, in the case where it is determined in STEP S215 that pen-up is not made, the CPU 71 proceeds to STEP S217 to draw the interpolating edge picture image on an edited object picture image. Also, the CPU 71 proceeds to STEP S218 to draw the interpolating pattern picture image overlapping the interpolating edge picture image to display an interpolating picture image, which is formed by overlapping the interpolating pattern picture image on the interpolating edge picture image, in STEP S219. Further, in order to erase a border generated in a border portion between the tip end picture image and the interpolating picture image, the CPU 71 proceeds to STEP S220 to draw the tip end picture image again.

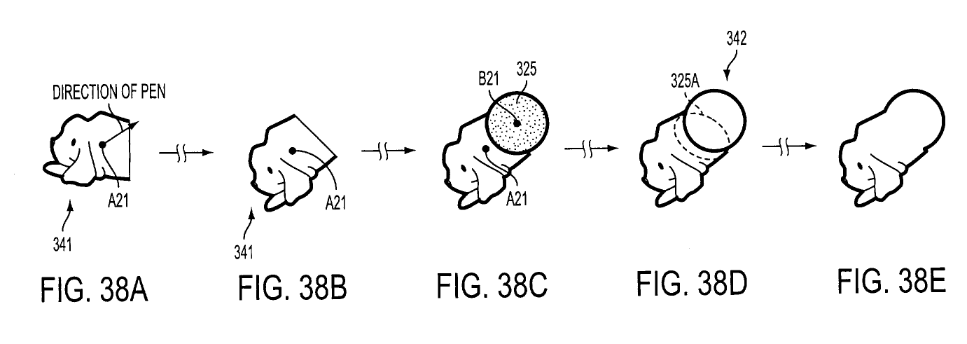

Concretely, in the case where the input pen 32 is moved as shown by an arrow in FIG. 38A, for example, in a state, in which the tip end picture image 341 as shown in FIG. 36B is displayed, the tip end picture image 341 is turned along a running direction of the input pen 32 as shown in FIG. 38B and the interpolating edge picture image 325 is drawn in a position B21 spaced a predetermined distance from the position A21 in the running direction of the input pen 32.

Also, as shown in FIG. 38D, the interpolating pattern picture image 324 is drawn overlapping the interpolating edge picture image 325 and so an interpolating picture image 342 is displayed. Also, since the interpolating edge picture image 325 generates an edge 325A in a border portion between the tip end picture image 341 and the interpolating picture image 342, the tip end picture image 341 is drawn again so as to erase the edge, and a picture image shown in FIG. 38E is displayed.

Returning again to an explanation for FIG. 35, the CPU 71 draws the tip end picture image in STEP S220 and then returns to STEP S215 to implement the succeeding processings repeatedly. That is, the interpolating picture image is drawn along a locus of the input pen 32 until the input pen makes pen-up.

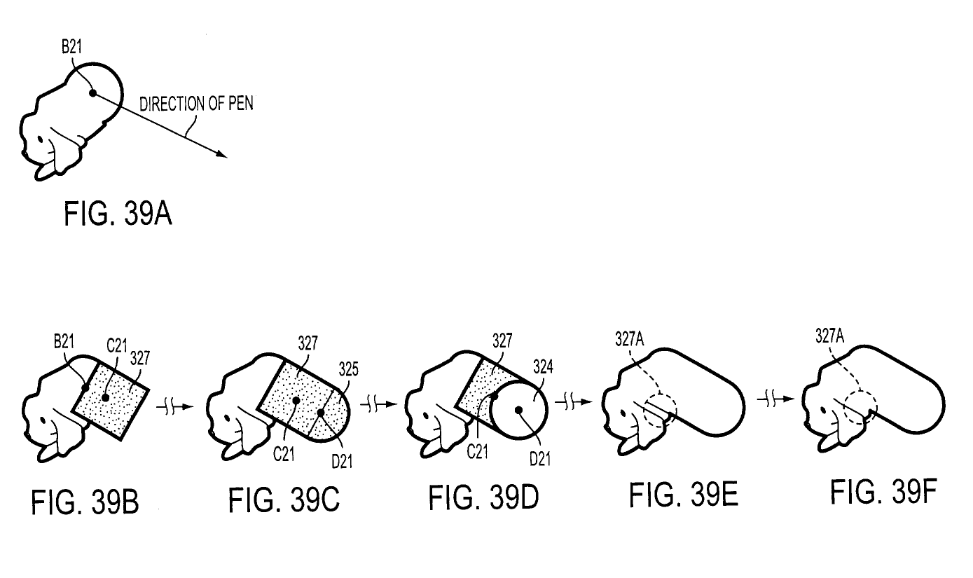

In the case where the input pen 32 is continuously moved as shown by an arrow shown in FIG. 39A, for example, in a state in which the same picture image as that shown in FIG. 38E is displayed, a square-shaped interpolating edge picture image 327 is drawn in a position C21, as shown in FIG. 39B, spaced a predetermined distance from the position B21 in an arrow direction and a circular-shaped interpolating edge picture image 325 is drawn in a position D21 further spaced a predetermined distance.

While the interpolating pattern picture image is drawn overlapping the interpolating edge picture image immediately after the interpolating edge picture image is drawn in the description with reference to FIG. 35, the interpolating edge picture image generates a border portion like the edge 325A. Therefore, the interpolating edge picture image and the interpolating pattern picture image are drawn suitably under control according to a running direction of the input pen 32 or a running speed of the input pen 32.

In addition, the circular-shaped interpolating edge picture image 325 and the square-shaped interpolating edge picture image 327 are drawn according to the running direction of the input pen 32. That is, in the case where a locus of the input pen 32 is substantially rectilinear, the square-shaped interpolating edge picture image 327 is drawn, and in the case where a locus of the input pen 32 includes an angle having at least a predetermined threshold, such as a right angle relative to the running direction, the circular-shaped interpolating edge picture image 325 is drawn in the front and the rear in a position where the angle is generated. Thereby, dispersion in dots drawn can be suppressed.

In this manner, after the interpolating edge picture image 327 is drawn in the position C21 and the interpolating edge picture image 325 is drawn in the position D21, the interpolating pattern picture image 324 is drawn overlapping the interpolating edge picture image 325 as shown in FIG. 39D and an interpolating pattern picture image 326 is drawn overlapping the interpolating edge picture image 327 as shown in FIG. 39E. Thereby, even when the interpolating edge picture image and the like are successively drawn, border portions therein can be erased by the interpolating pattern picture images.

Also, in order to erase a border 327A, shown in FIG. 39E, between the interpolating edge picture image 327 and the tip end picture image 341, the tip end pattern picture image 321 is drawn again and so a picture image, in which the border 327A as shown in FIG. 39F is erased, is displayed.

Making use of such elongation stamp, a user can create an interesting picture image. In addition, while a user operates the “elongation stamp” button 207 to select a desired one from stamp picture images beforehand prepared, the stamp picture image created in the above manner (stamp picture image kept in the photographing processing and created in the edition processing) may be elongated along a locus.

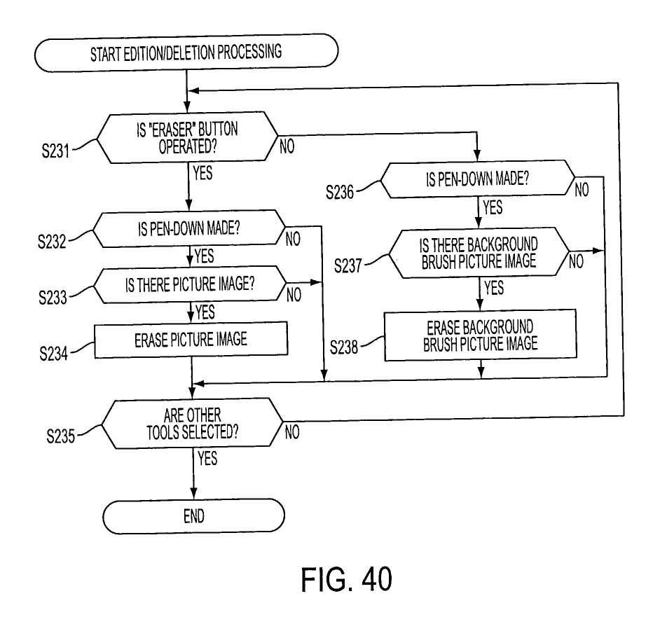

Subsequently, an explanation will be given to an edition/erasing processing, which is implemented when an eraser tool is selected from the eraser menu 156 in the edition processing, with reference to a flowchart shown in FIG. 40.

As described above, prepared in the eraser menu 156 are the “eraser tool” capable of erasing all scribbles such as a pen picture image input by the pen tool, a stamp picture image input by the stamp tool and a background brush picture image input by the background brush tool, and the “background brush tool” capable of erasing only a background brush picture image input as a background of a subject by the background brush tool.

When either of the “eraser tool” and the “background brush” tool is selected, the CPU 71 determines in STEP S231 whether the “eraser” tool is selected, that is, the “eraser” button 221 shown in FIG. 10 is operated.

In the case where it is determined that the “eraser” button 221 is operated, the CPU 71 proceeds to STEP S232 to determine whether the input pen 32 makes pen-down on an edited object picture image. In the case where it is determined in STEP S232 that pen-down is not made, the CPU 71 skips processings in STEP S233 and STEP S234 described later, and in the case where it is determined that pen-down is made on an edited object picture image, the CPU 71 proceeds to STEP S233 to determine whether one of the pen picture image, the stamp picture image, and the background brush picture image is present in the pen-down position. In the case where it is determined in STEP S233 that no picture image is present in the pen-down position, the CPU 71 skips the processing in STEP S234.

In the case where it is determined in STEP S233 that a pen picture image input by the pen tool, or a stamp picture image input by the stamp tool, or a background brush picture image input by the background brush tool is present in the pen-down position, the CPU 71 proceeds to STEP S234 to erase all picture images present in the pen-down position.

In the case where it is determined in STEP S235 whether tools other than the “eraser” tool, that is, other tools such as the pen tool and the stamp tool, are selected and it is determined that other tools are not selected, the CPU 71 returns to STEP S231 to implement the above processings repeatedly, and on the other hand, in the case where it is determined that other tools are selected, the CPU 71 terminates the processing.

Meanwhile, in the case where it is determined in STEP S231 that the “eraser” button 221 is not operated, that is, the “background brush eraser” button 222 is operated, the CPU 71 proceeds to STEP S236 to determine whether pen-down is made.

In the case where it is determined in STEP S236 that pen-down is made, the CPU 71 proceeds to STEP S237 to determine whether a background brush picture image input by the background brush tool is present in the pen-down position. In the case where it is determined in STEP S237 that a background brush picture image input by the background brush tool is present in the pen-down position, the CPU 71 proceeds to STEP S238 to erase only the background brush picture image. That is, even when a pen picture image or a stamp picture image is input overlapping a background brush picture image, only the background brush picture image is erased.

In the case where it is determined in STEP S235 that other tools are selected, the processing is terminated.

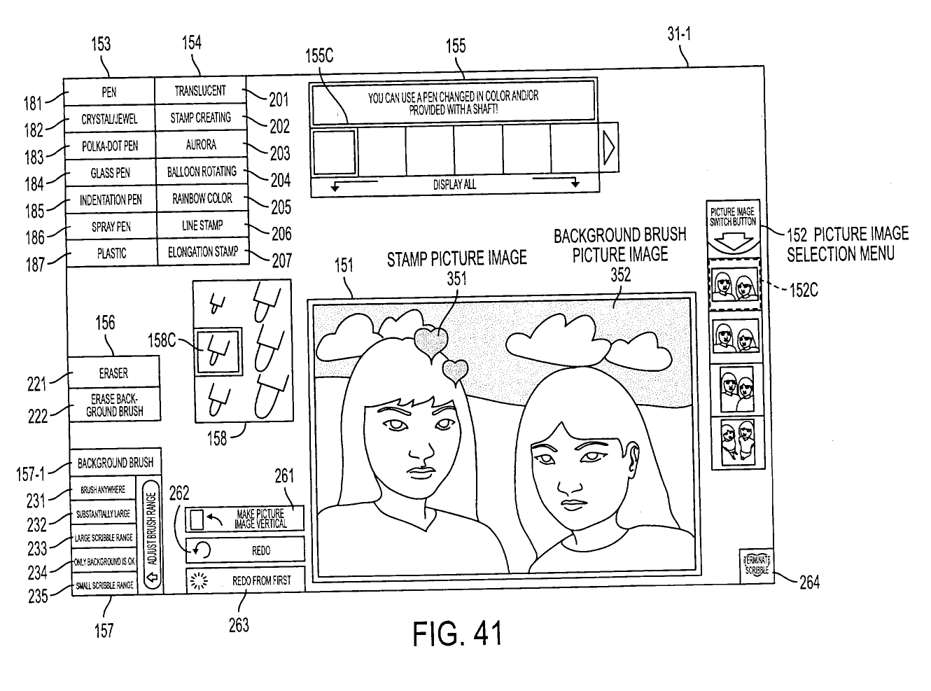

FIG. 41 is a view showing a display example of a scribble screen. In the case where the input pen 32 touches a stamp picture image 351 in a state, in which the “eraser” button 221 is operated and the “eraser tool” is selected in the above processings, regions of the stamp picture image 351 and a background brush picture image 352 disposed below the stamp picture image 351 are erased.

Also, in the case where the input pen 32 touches the background brush picture image 352, for example, in a state, in which the “background brush eraser” button 222 is operated and the “background brush eraser tool” is selected, only a portion of the background brush picture image 352 in a region or regions touched by the input pen is erased.

Thereby, a user can correct edition efficiently and rapidly. More specifically, if a “background brush eraser” tool were not prepared, a user could not erase only the background brush picture image. Also, if only a “background brush eraser” tool and a “foreground eraser” tool (pen picture image, stamp picture image) were prepared, a user must select and erase respective eraser tools each time in the case of erasing a background brush picture image as well as a pen picture image and a stamp picture image.

Subsequently, an explanation will be given to an operation of the picture image printing apparatus 1, which enables a user to operate the above various processings easily and intuitionally.

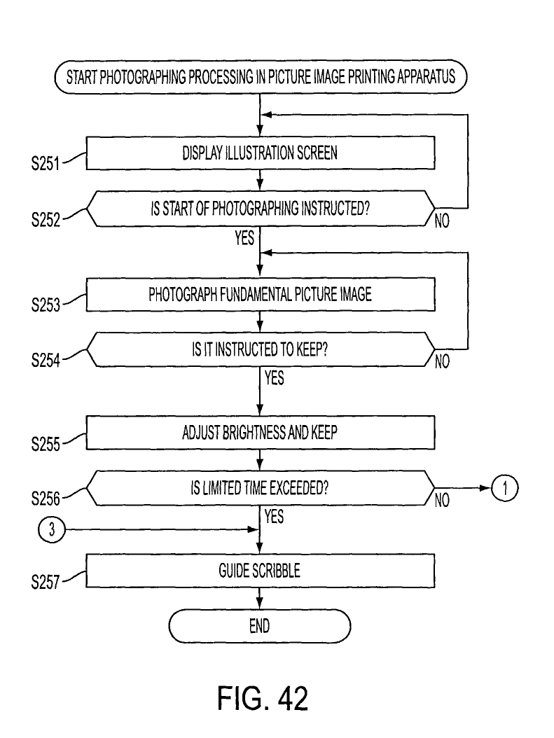

First, an explanation will be given to a photographing processing of the picture image printing apparatus 1 with reference to a flowchart shown in FIG. 42.

A processing shown in FIG. 42 is a simplification of the processing described with reference to the flowchart shown in FIG. 7, and the processing corresponding to STEP S6 to STEP S11 in FIG. 7 is omitted.

That is, photographing is taken in STEP S253 when the photographing monitor 16 displays an illustration screen illustrating a photographing method or the like and a user adjusts the level and angle of the photographing device 12 to instruct the start of photographing in STEP S251. Also, in the case where it is instructed to keep picture images photographed, picture image data is kept after brightness is adjusted in STEP S255, and when a limited time set for the photographing processing has not elapsed, the photograph retaking processing is done as described with reference to STEP S14 to STEP S22 in FIG. 8.

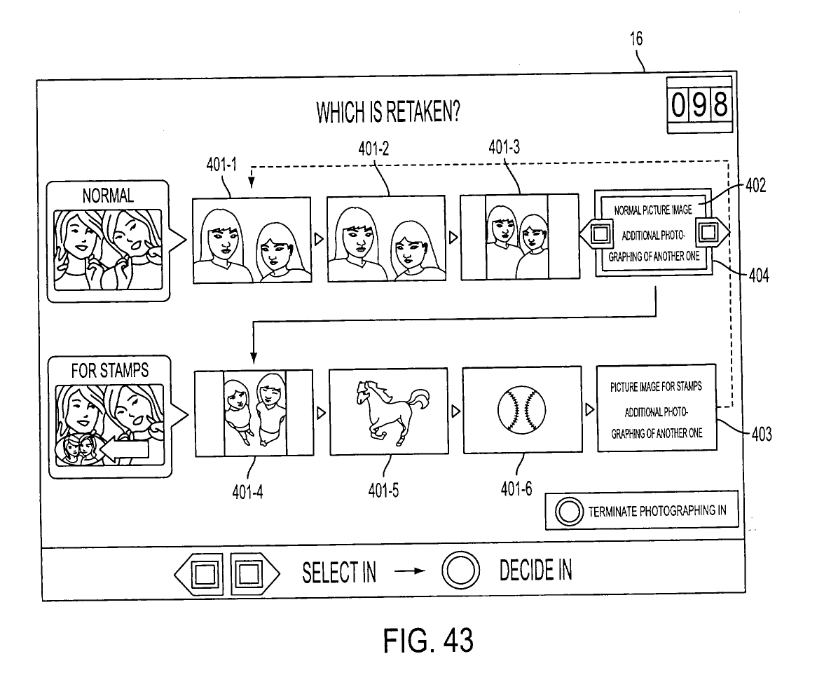

FIG. 43 is a view showing a display example of a retaking/adding photographing screen presented to a user who retakes and adds a picture image.

As shown in the figure, since picture images as photographed are displayed in tabulation, a user can compare a plurality of picture images with one another to move a cursor 404 to select a predetermined picture image and to photograph the same again. In the example shown in FIG. 43, a message “Which is retaken?” is displayed above the photographing monitor 16, fundamental picture images (normal picture images in the figure) 401-1 to 401-3 and stamp picture images (picture images for stamps in the figure) 401-4 to 401-6 being displayed below the message. Also, an additional photographing button 402 operated in additionally photographing a fundamental picture image or images, and an additional photographing button 403 operated in additionally photographing a stamp picture image or images are displayed, whereby a user moves the cursor 404 to select these buttons, thereby enabling additionally photographing picture images.

Further, in the example shown in FIG. 43, an operation guide for selection of picture images being photographed again is displayed below the fundamental picture images and the stamp picture images, according to which operation guide right and left buttons on the operation panel 17 are used to move the cursor 404 to select a picture image and a decision button (O button) is used for decision.

In addition, the stamp picture images 401-5, 401-6 (picture image of animal and picture image of ball) are not ones photographed by a user but ones prepared beforehand for the retaking screen. Predetermined picture images are beforehand prepared as stamp picture images in this manner, whereby a user can edit picture images thus prepared and synthesize stamp picture images thus created and a fundamental picture image.

A user photographs picture images again according to such screens and moves from the photographing space 42 according to a guide displayed on the photographing monitor 16 in STEP S257 when a limited time set for the photographing processing (remaining time “98 seconds” is displayed upwardly rightward on the screen in the example shown in FIG. 43) has elapsed.

Also, in the retaking screen shown in FIG. 43, picture images may be altered in attribute such that picture images being fundamental picture images are made stamp picture images and on the contrary picture images being stamp picture images are made fundamental picture images. For example, the fundamental picture image 401-1 is moved to a position, in which the stamp picture image 401-5 is displayed, in dragging manner and can be changed to a stamp picture image, whereby labor of photographing the same picture image again can be omitted.

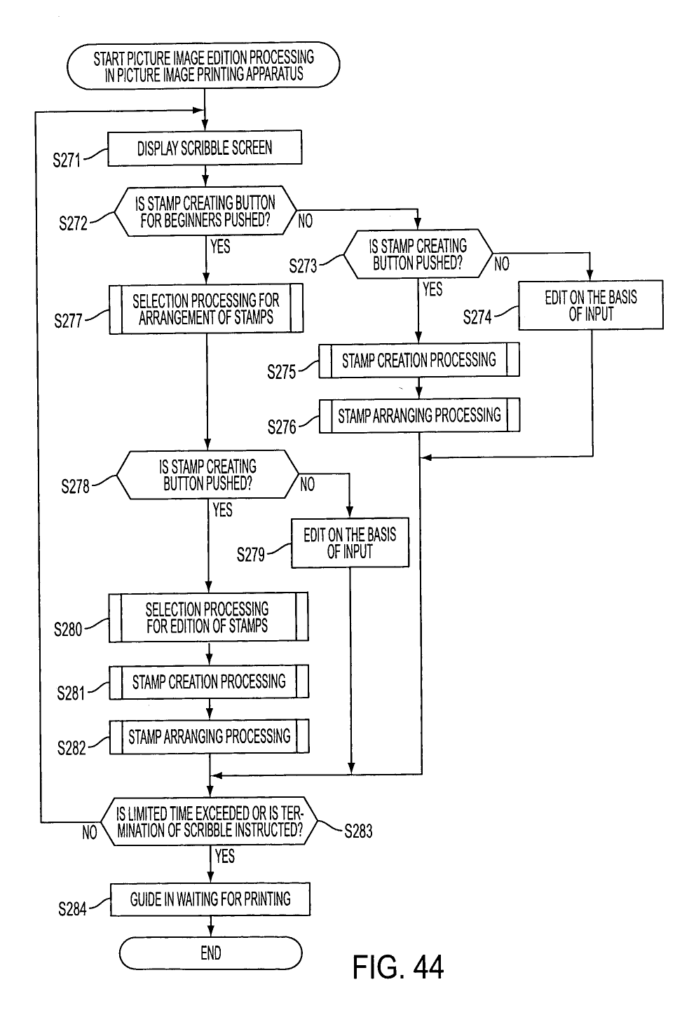

Subsequently, an explanation will be given to a picture image editing processing performed in the picture image printing apparatus 1 with reference to a flowchart shown in FIG. 44.

The processing shown in FIG. 44 is essentially the same as that shown in FIG. 13 and is different therefrom in that there is contained a processing for displaying a guide capable of easily creating and arranging stamp picture images.

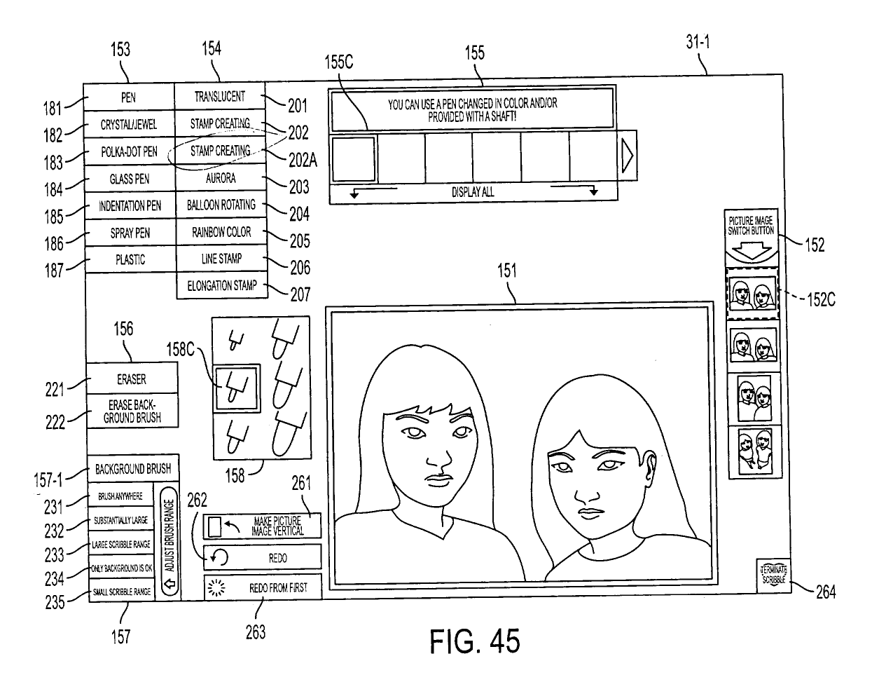

That is, in STEP S271, the editing monitor 31 displays a scribble screen shown in, for example, FIG. 45. As shown in FIG. 45, the stamp menu 154 on the scribble screen further prepares a stamp creating button 202A for beginners, below the stamp creating button 202 for a user, who is not accustomed to creation of stamp picture images. Other items as displayed are the same as those shown in FIG. 10 and thus further explanation will be omitted.

In the case where it is determined in STEP S272 whether the stamp creating button 202A for beginners is pushed and it is determined that the button is not pushed, the CPU 71 implements in STEP S273 to STEP S275 the same processings as those in STEP S32 to STEP S35 shown in FIG. 9.

More specifically, when the stamp creating button 202 is pushed, the stamp creating processing described with reference to FIG. 11 and the stamp arranging processing described with reference to FIG. 20 are carried out.

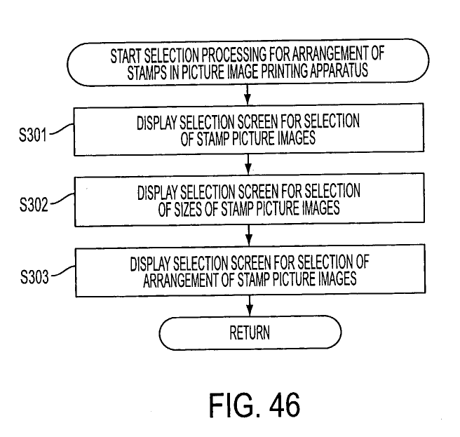

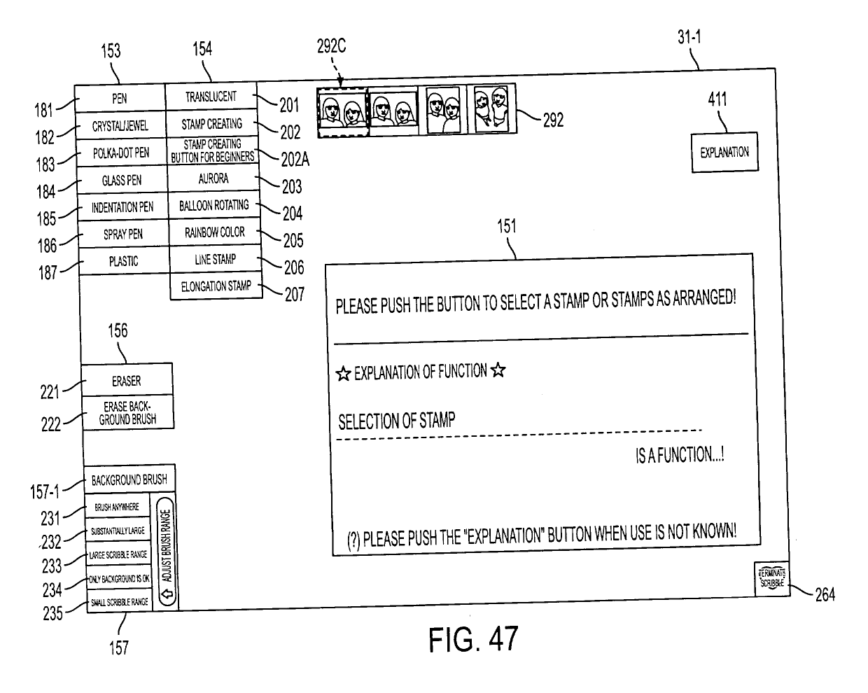

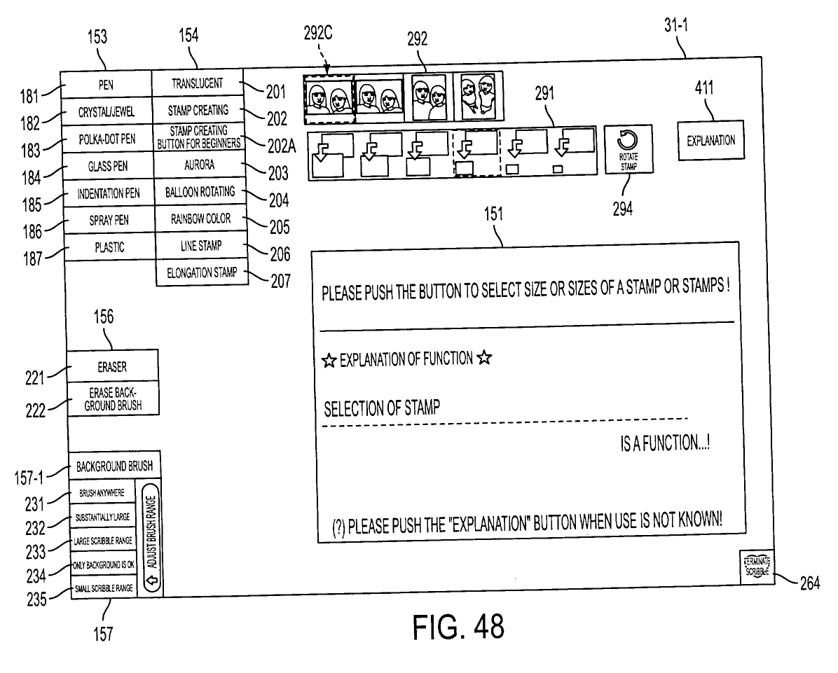

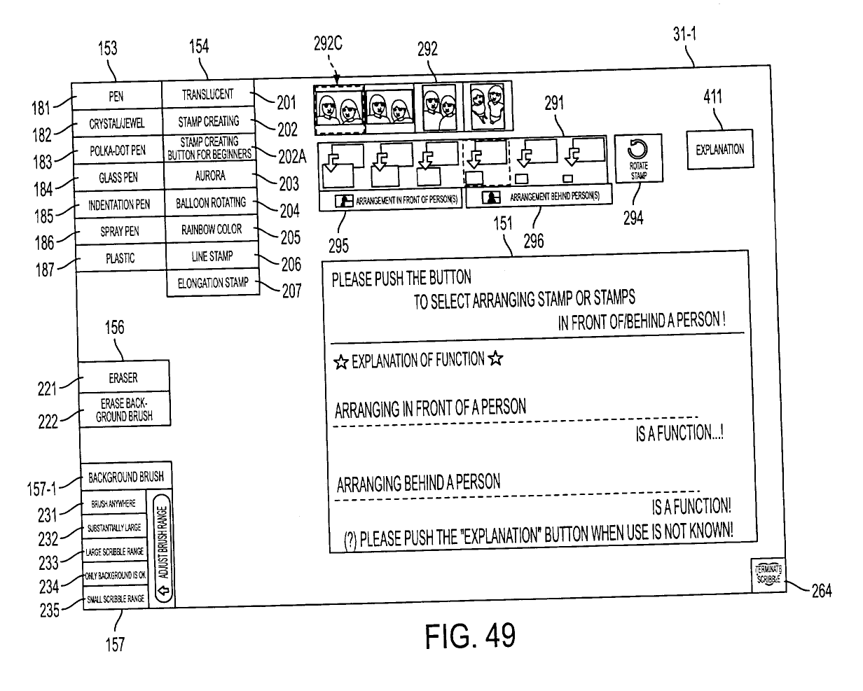

Meanwhile, in the case where it is determined in STEP S272 that the stamp creating button 202A for beginners is pushed, the CPU 71 proceeds to STEP S277 to implement a selection processing for stamp arrangement. The CPU 71 sequentially displays a picture image selection screen (see FIG. 47) for selection of stamp picture images, a size selection screen (see FIG. 48) for selection of sizes of stamp picture images, and a selection screen (see FIG. 49) for selection of a method of arranging stamp picture images (i.e. whether stamp picture images should be arranged as a foreground of a subject region in a fundamental picture image), and allows selection by a user. Details of a selection processing for arrangement of stamps will be described later with reference to a flowchart shown in FIG. 46.

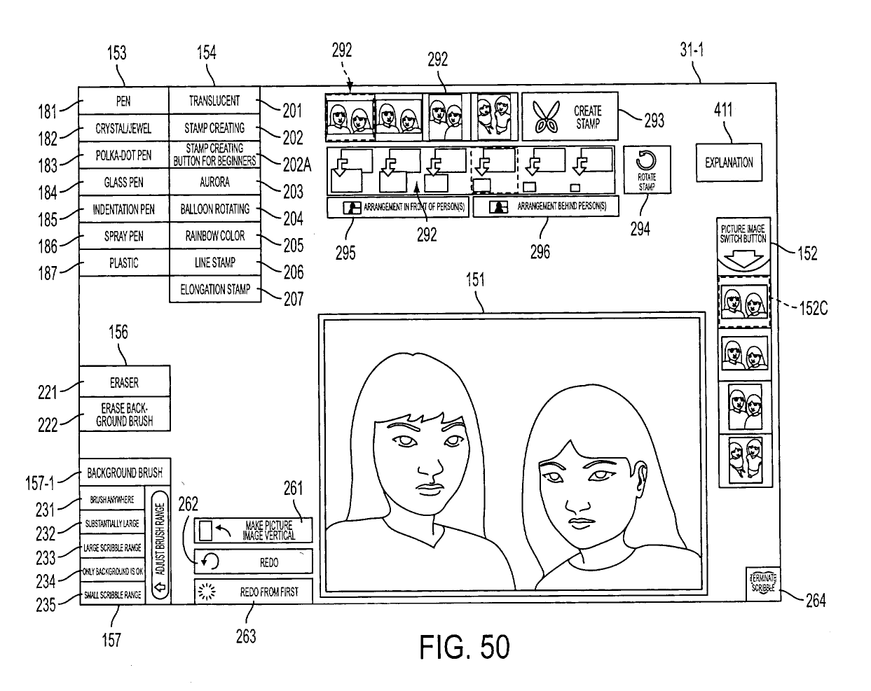

After the selection processing for arrangement of stamps is carried out in STEP S277, the editing monitor 31 displays the stamp creating button 293 (see FIG. 50) operated in creating and correcting stamp picture images, so that in the case where it is determined in STEP S278 whether the stamp creating button 293 is pushed and it is determined that the button is not pushed, the CPU 71 proceeds to STEP S279 to synthesize pen picture images, stamp picture images, and a fundamental picture image on the basis of an input from a user.

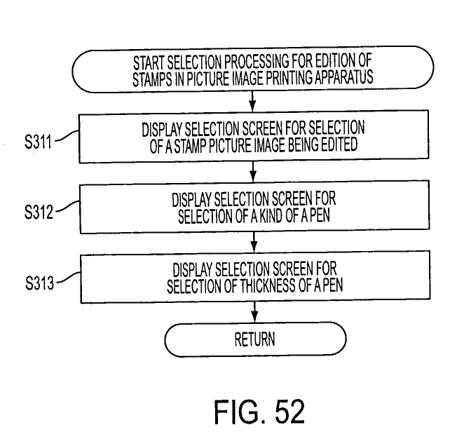

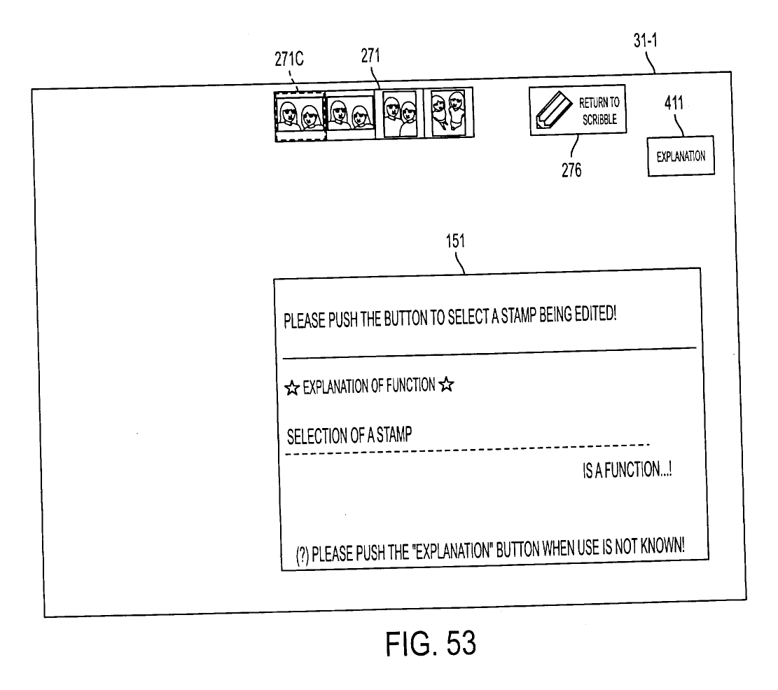

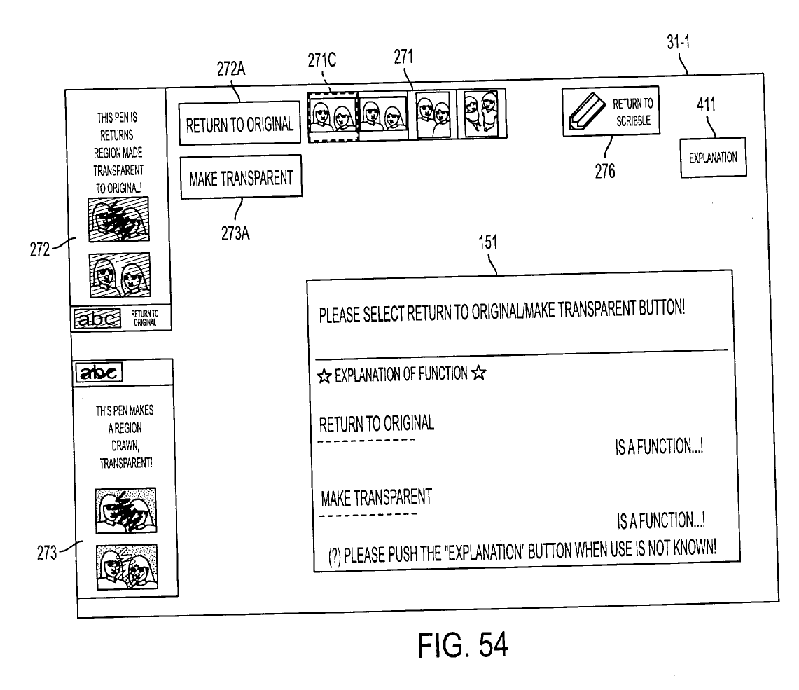

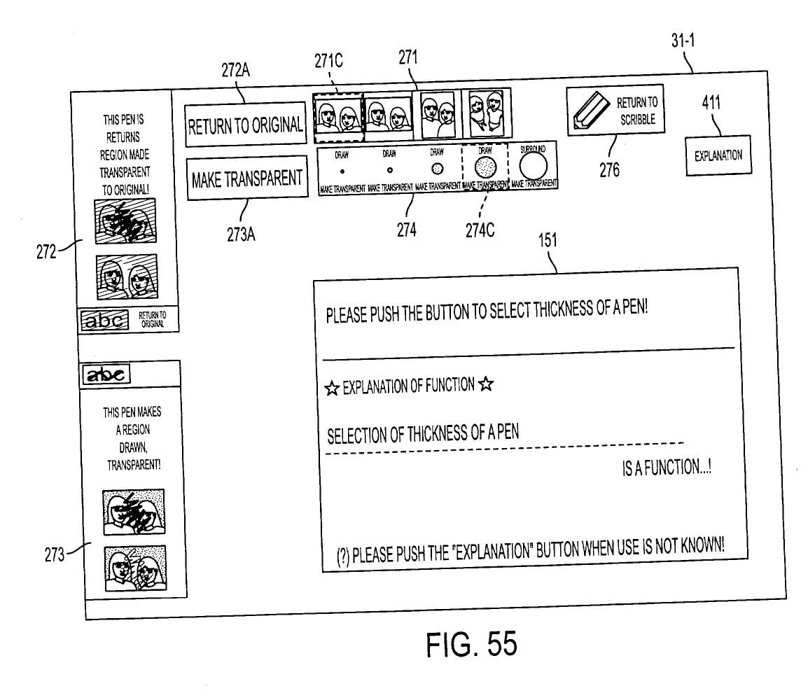

In the case where it is determined in STEP S278 that the stamp creating button 293 is pushed, the CPU 71 proceeds to STEP S280 to implement the selection processing for edition of stamps. The CPU 71 sequentially displays a picture image selection screen for selection of stamp picture images being edited (see FIG. 53), a selection screen for selection of a method of indicating a region or regions used as stamp picture images (i.e. whether a region or regions painted out by the input pen 32 should be made a region or regions not used as stamp picture images) (see FIG. 54), and a thickness selection screen for selection of wideness (range) of a locus of a pen (see FIG. 55), and allows selection by a user. Details of the selection processing for edition of stamps will be described later with reference to a flowchart shown in FIG. 52.

In STEP S281, the CPU 71 implements the processing described with reference to FIG. 11 and creates stamp picture images on the basis of various settings selected in the selection processing for edition of stamps and an input from a user. Also, in STEP S282, the CPU 71 implements the processing described with reference to FIG. 20 and synthesizes the created stamp picture images and a fundamental picture image on the basis of various settings selected in the selection processing for arrangement of stamps and an input from a user.

In the case where it is determined in STEP S283 that a limited time preset for the scribble processing has elapsed or termination of the scribble processing has been instructed, the CPU 71 guides a user in waiting for printing and terminates the processing. A user moves from the editing space 51 according to a guide displayed on the editing monitor 31.

Subsequently, an explanation will be given to the selection processing for arrangement of stamps implemented in STEP S277 shown in FIG. 44 with reference to a flowchart shown in FIG. 46.

In STEP S301, the CPU 71 causes the editing monitor 31 to display a selection screen for allowing a user to select stamp picture images.

FIG. 47 is a view showing an example of a selection screen displayed in STEP S301. In the example shown in FIG. 47, displayed on an upper portion of the editing monitor 31-1 is only the picture image selection menu 292 among the size selection menu 291, the picture image selection menu 292, the stamp creating button 293, the stamp rotating button 294, the foreground arranging button 295 and the background arranging button 296 as shown in FIG. 21.

Also, the edited object picture image displaying section 151 displays a message “Please push the button to select a stamp or stamps as arranged!” and an explanation with respect to “selection of stamp” is displayed below the message.

In this manner, since the editing monitor 31 displays only the picture image selection menu 292 among the size selection menu 291, the picture image selection menu 292, the stamp creating button 293, the stamp rotating button 294, the foreground arranging button 295 and the background arranging button 296, a user can intuitionally recognize selection of stamp picture images as what should be done. Also, a user consults the explanation displayed on the edited object picture image displaying section 151 to be able to ascertain details of the function and to select stamp picture images efficiently.

In addition, in the display example shown in FIG. 47, displayed rightwardly upward on the editing monitor 31 is an explanation button 411 operated when more detailed explanation is displayed for a user, who is at a loss in operation even in the case where these displays are recognized. As described later, the explanation button 411 is displayed on display screens shown in FIGS. 48 and 49.

When a picture image is selected from the picture image selection menu 292, the CPU 71 proceeds to STEP S302 to cause the editing monitor 31 to display a selection screen for allowing a user to select sizes of stamp picture images.

FIG. 48 is a view showing an example of a selection screen displayed in STEP S302. In the example shown in FIG. 48, a size selection menu 291 is displayed below the picture image selection menu 292. Also, the edited object picture image displaying section 151 displays a message “Please push the button to select a size or sizes of a stamp or stamps I” and an explanation with respect to “selection of stamp” is displayed below the message.

In this manner, when a picture image or images are selected on the picture image selection menu 292, a user can intuitionally recognize selection of a size or sizes of a stamp picture image or images as what should be done since the size selection menu 291 is displayed below the picture image selection menu 292.

When a picture image or images are selected from the size selection menu 291, the CPU 71 proceeds to STEP S303 to cause the editing monitor 31 to display a selection screen for allowing a user to select an arrangement of stamp picture images.

FIG. 49 is a view showing an example of a selection screen displayed in STEP S303. In the example shown in FIG. 49, the foreground arranging button 295 and the background arranging button 296 are displayed below the size selection menu 291. Also, the edited object picture image displaying section 151 displays a message “Please push the button to select arranging a stamp or stamps in front of a person or arranging a stamp or stamps behind a person!” and an explanation with respect to the function of “arranging a stamp or stamps in front of a person (a subject)” and the function of “arranging a stamp or stamps as a background of a person” is displayed below the message.

In this manner, when a size or sizes of a picture image or images are selected on the size selection menu 291, a user can intuitionally recognize selection of arrangement of a stamp picture image or images as what should be alone since the foreground arranging button 295 and the background arranging button 296 are displayed below the size selection menu 291.

When the foreground arranging button 295 or the background arranging button 296 is pushed and arrangement of a stamp picture image or images is selected, the CPU 71 causes the editing monitor 31 to display a screen as shown in FIG. 50 and thereafter implements the processings succeeding STEP S277 shown in FIG. 44. In FIG. 50, the stamp creating button 293 is displayed on the next door on the right side of the size selection menu 291.

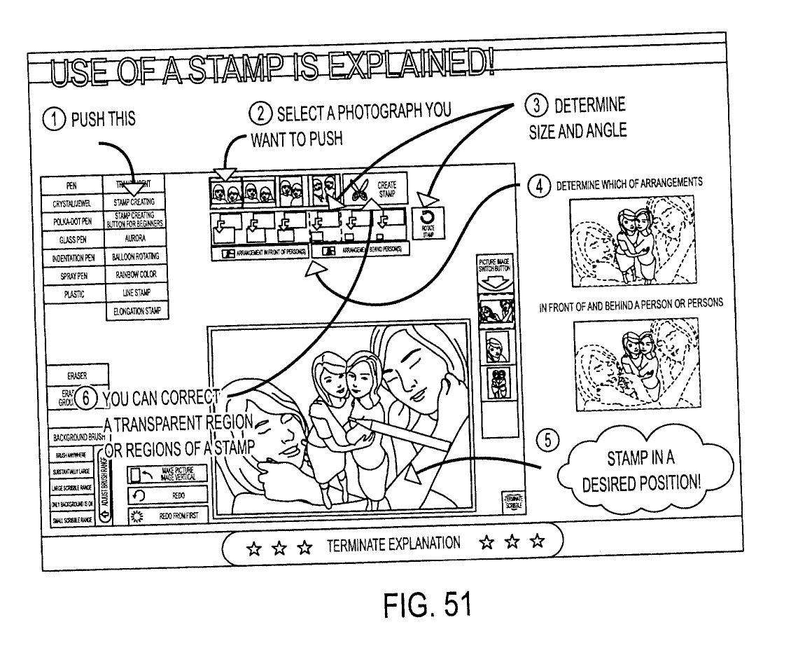

In addition, FIG. 51 is a view showing an example of an explanation screen displayed when the explanation button 411 is operated in a state in which a screen shown in FIGS. 47 to 49 is displayed, and an image screen explaining a series of processings until a stamp picture image or images are arranged on a fundamental picture image is displayed as an explanation screen. Each time a function is increased, an operation therefore is generally made complex, so that the series of processings (stamp creating processing, stamp arranging processing) are displayed as a whole in this manner, whereby a user can easily catch the meaning of an operation, which he is presently doing.

In the display example shown in FIG. 51, it is suggested to push the stamp creating button 202 (the stamp creating button 202A for beginners) as a first operation for arrangement, to create a stamp picture image or images from the picture image selection menu 292 as a second operation, and to select a size of a picture image from the size selection menu 291 and push the stamp rotating button 294 for determination of an angle as a third operation. Also, it is suggested to select the foreground arranging button 295 or the background arranging button 296 to select arranging a stamp picture image or images as a foreground of a subject or arranging a stamp picture image or images as a background as a fourth operation, to arrange a stamp picture image or images in a desired position or positions on a fundamental picture image as a fifth operation, and to push the stamp creating button 293 to enable correction of a stamp picture image or images as a sixth operation.

By selecting “Terminate explanation” displayed in a lower portion on a screen shown in FIG. 51, a user can return to respective screens in FIGS. 47 to 49.

Subsequently, an explanation will be given to the selection processing for edition of stamps in STEP S280 shown in FIG. 44 with reference to a flowchart shown in FIG. 52.

In STEP S311, the CPU 71 causes the editing monitor 31 to display a selection screen for allowing a user to select a stamp picture image or images being edited.

FIG. 53 is a view showing an example of a selection screen displayed in STEP S311. In the example shown in FIG. 53, displayed on an upper portion of the editing monitor 31 are only the picture image selection menu 271 and the return button 276 among the picture image selection menu 271, the region erasing button 272, the region addition button 273, the stamp picture image displaying section 275 and the return button 276 shown in FIG. 12.

Also, the edited object picture image displaying section 151 displays a message “Please push the button to select a stamp being edited!” and an explanation with respect to “selection of stamp” is displayed below the message.

In this manner, since the editing monitor 31 displays only the picture image selection menu 271 and the return button 276 among the picture image selection menu 271, the region erasing button 272, the region addition button 273, the stamp picture image displaying section 275 and the return button 276, a user can intuitionally recognize selection of a stamp picture image or images being edited as what should be done.

In addition, in FIGS. 53, 54, and 55, displayed in the upper right portion of the editing monitor 31 is an explanation button 411 operated when more detailed explanation is displayed for a user, who is at a loss in operation.

When a picture image is selected from the picture image selection menu 271, the CPU 71 proceeds to STEP S312 to cause the editing monitor 31 to display a selection screen for allowing a user to select a kind of a pen.

FIG. 54 is a view showing an example of a selection screen displayed in STEP S312. In the example shown in FIG. 54, the region erasing button 272, the region addition button 273, a “return to original” button 272A, and a “make transparent” button 272B, the last two of which correspond to the region erasing button 272 and the region addition button 273, respectively, are displayed in addition to the screen shown in FIG. 53.

A user can add a region used as a stamp picture image by operating the region erasing button 272 or the “return to original” button 272A to paint out a stamp picture image by means of the input pen 32, and erase a region used as a stamp picture image by operating the region addition button 273 or the “make transparent” button 272B to paint out a stamp picture image by means of the input pen 32.

Also, the edited object picture image displaying section 151 displays a message “Please select return to original/make transparent button!” and an explanation with respect to “return to original” and “make transparent” is displayed below the message.

In this manner, since the region erasing button 272, the region addition button 273, and the like are displayed when a picture image is selected on the picture image selection menu 271, a user can intuitionally recognize selection of a method of creating a stamp picture image or images being edited as what should be done.

When a method of creating a stamp picture image is selected, the CPU 71 proceeds to STEP S313 to cause the editing monitor 31 to display a selection screen for allowing a user to select a thickness (a range that can be painted out at a time) of the input pen 32.

FIG. 55 is a view showing an example of a selection screen displayed in STEP S313. In the example shown in FIG. 55, the thickness selection menu 274 is displayed below the picture image selection menu 271. Also, the edited object picture image displaying section 151 displays a message “Please push the button to select thickness of a pen!” and an explanation with respect to the function “selection of thickness of a pen” is displayed below the message.

In this manner, since the thickness selection menu 274 is displayed when a creating method (whether a region or regions painted out should be made a stamp picture image) is selected, user can intuitionally recognize selection of wideness of locus of the input pen 32 as what should be done.

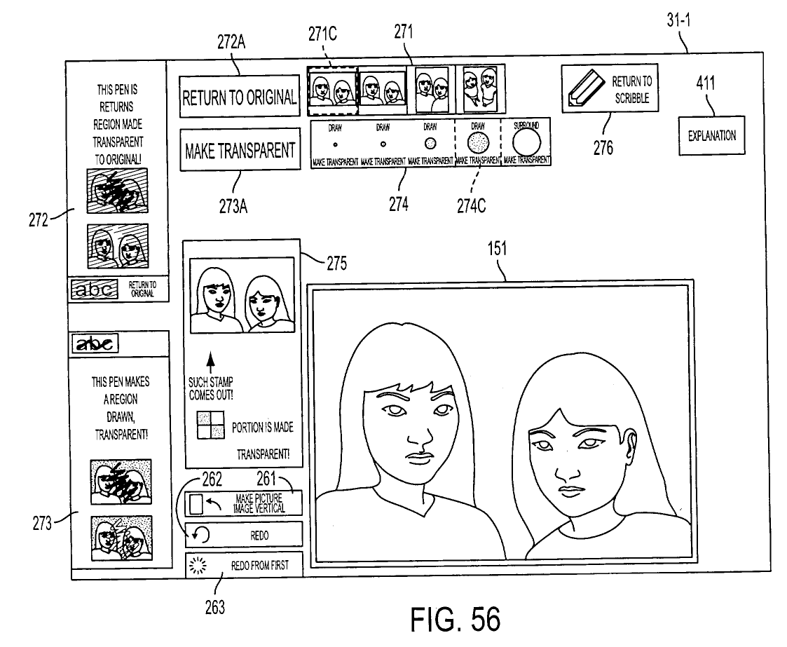

When wideness of a locus of the input pen 32 is selected, the CPU 71 causes the editing monitor 31 to display a screen as shown in FIG. 56 and implements the processings succeeding STEP S280 shown in FIG. 44. More specifically, in STEP S281 shown in FIG. 44, a region or regions used as a stamp picture image are indicated for a stamp picture image selected in the selection processing for edition of stamps, in the selected wideness of a locus of the input pen 32 and the selected creating method. Also, in STEP S282, a stamp picture image and a fundamental picture image are synthesized in a size selected in the selection processing for edition of stamps and a method of arrangement as selection.

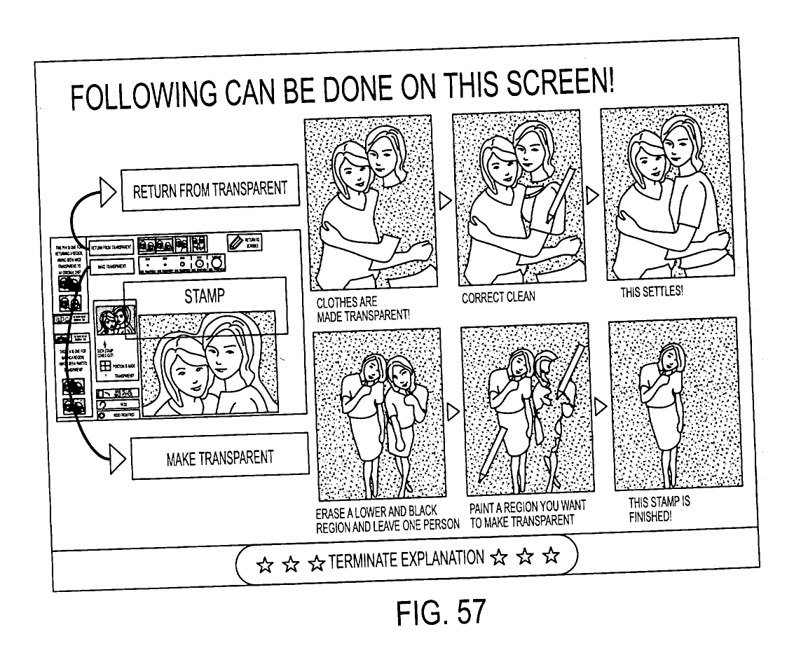

In addition, FIG. 57 is a view showing an example of an explanation screen displayed when the explanation button 411 is displayed in a state, in which a screen shown in FIGS. 54 to 56 is displayed, and a series of processings in indicating a region or regions used as a stamp picture image are displayed as an explanation screen.

In this manner, since various items of selection are displayed in order and allow selection by a user, a user, who is not accustomed to creation of stamp picture images, can create a stamp picture image efficiently.

While a stamp picture image composed of a region or regions indicated by a user and a fundamental picture image are synthesized in the above processings, a region or regions, which are indicated by a user and to which a frame picture image composed of, for example, a plurality of picture images, such as heart patterns or flower patterns, connected is added, may be synthesized.

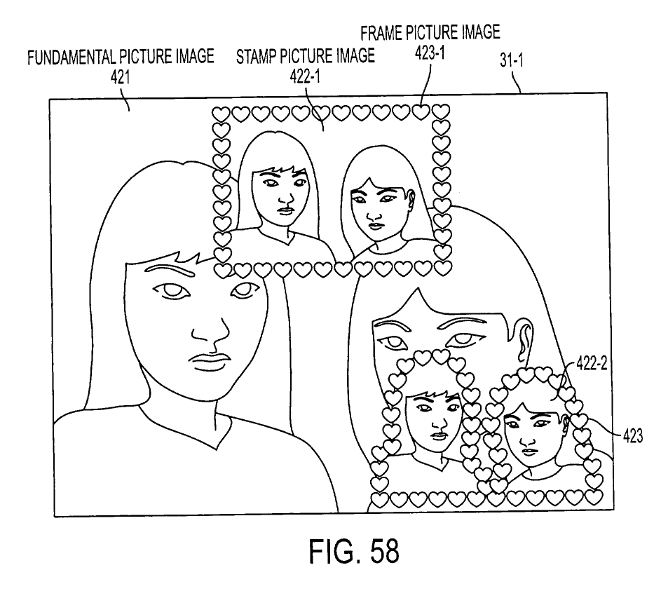

FIG. 58 is a view showing an example of a-picture image, into which a stamp picture image with a frame picture image added is synthesized.

In FIG. 58, stamp picture Images 422-1, 422-2 are input as a foreground of a subject in a fundamental picture image 421, and frame picture images 423-1, 423-2 are added to the respective stamp picture images.

In addition, added to the stamp picture image 422-2 is the frame picture image 423-2, which heart-shaped picture images continue in an outline of a subject (outline of a region edited by a user) to constitute.

Also, while other items are not displayed and an item (menu) being subsequently selected is displayed in emphasis in the above processings, the item subsequently selected may be displayed in flickering manner.

Further, in the explanation screen shown in FIGS. 51 and 52, a processing presently carried out by a user may be displayed in flickering manner or indicated by a message so as to enable a user to easily ascertain the processing presently carried out.

As described above, it is possible according to the invention to preferably extract a desired region or regions in a picture image and synthesize the same and a predetermined picture image.

While preferred embodiments of the present invention have been shown in the drawings and described above, it will be apparent to one skilled in the art that various embodiments of the present invention are possible. Therefore, the present invention should not be construed as limited to the specific form shown and described above

What is claimed as new and desired to be protected by Letters Patent of the United States is:

1. A picture image printing apparatus, comprising:
a photographing means for photographing a subject;
a picture image selecting means for selecting a first picture image and a second picture image from picture images photographed by said photographing means;
a region extracting means for extracting a synthesized region or regions from said second picture image according to an input from a user; and
a synthesizing means for synthesizing said synthesized region or regions of said second picture image into said first picture image.

2. The picture image printing apparatus according to claim 1, further comprising input means for inputting the synthesized region or regions.

3. The picture image printing apparatus according to claim 2, wherein said input means is an input pen.

4. The picture image printing apparatus according to claim 3, wherein said input pen is configured in accordance with a position detecting system, such as a resistance-film system, ultrasonic wave system, or the like.

5. The picture image printing apparatus according to claim 2, wherein said region extracting means extracts a region or regions of said second picture image except a region or regions within a locus of said input means.

6. The picture image printing apparatus according to claim 5, wherein the region or regions surrounded by a locus of said input means displays a picture image or images so as to indicate that said region or regions is not selected for extraction by said extraction means.

7. The picture image printing apparatus according to claim 1, wherein the region extracting means extracts a region or regions of the second picture image, which meet with a predetermined setting relating to color and indicated by a user.

8. The picture image printing apparatus according to claim 1, wherein said synthesizing means synthesizes said synthesized region or regions as a foreground of the first picture image or as a background of the first picture image.

9. The picture image printing apparatus according to claim 8, further comprising a first flattening means for flattening an outline of a subject in the first picture image when said synthesized region or regions are synthesized with said first picture image as a background of said subject in the first picture image.

10. The picture image printing apparatus according to claim 8, further comprising a second flattening means for flattening an outline of a synthesized region or regions when said synthesized region or regions are synthesized with said first picture image as a foreground of said first picture image.

11. The picture image printing apparatus according to claim 1, further comprising a display means for displaying a predetermined picture image, which emphasizes the outline of the region of the subject.

12. The picture image printing apparatus according to claim 1, further comprising a synthesized region display means for displaying the synthesized region or regions extracted by said region extracting means, wherein said synthesized region display means displays said synthesized region separately from the display of said second picture image where input from a user is received.

13. The picture image printing apparatus according to claim 1, wherein said photographing means is a CCD camera.

14. A picture image printing method comprising the steps of:
photographing a subject;
selecting a first picture image and a second picture image from picture images photographed in said photographing step;
extracting a synthesized region or regions from said second picture image according to an input from a user; and
synthesizing said synthesized region or regions of said second picture image into said first picture image.

16. The picture image printing method of claim 15, wherein said step of extracting a synthesized region further comprises the step of placing undesired regions of said second picture image within a locus of an input means according to the input of a user.

17. The picture image printing method of claim 16, wherein said step of extracting a synthesized region further comprises the step of extracting a region or regions from said second picture image, which are not with thin the locus of said input means.

18. A program for computer controlled picture image acquisition comprising the steps of:
controlling acquisition of a picture image of a subject photographed;
a picture image selecting step of selecting a first picture image and a second picture image from picture images of said subject acquired by said picture image acquisition step;
a region extracting step of extracting a synthesized region or regions from said second picture image selected by a processing of the picture image selecting step according to an input from a user;
and a synthesizing step of synthesizing the synthesized region or regions of the second picture image, extracted by a processing of the region extracting step, and the first picture image.

19. The program for computer controlled picture image acquisition of claim 18, wherein said step of extracting a synthesized region or regions from said second picture image further comprises the steps of placing undesired regions of said second picture image within the locus of an input means according to input from a user and extracting a synthesized region or regions from said second picture image regions which are not within the locus of said input means.

20. A printing medium unit for use in a picture image printing apparatus comprising:
a photographing means for photographing a subject;
a picture image selecting means for selecting a first picture image and a second picture image from picture images of the subject photographed by the photographing means;
a region extracting means for extracting a synthesized region or regions from said second picture image, said synthesized region or regions selected according to an input from a user;
a synthesizing means for synthesizing the synthesized region or regions of the second picture image extracted by the region extracting means and the first picture image;
a storage means for storing identifying information, which identifies the printing medium unit and wherein the identifying information stored in the storage means is usable when certified by the picture image printing apparatus.
